(19) United States
(12) Patent Application Publication
(10) Pub. No.: US 2012/0179678 A1
(43) Pub. Date: Jul. 12, 2012

(54) METADATA COLLECTING DEVICE

(75) Inventors: Yuji IRIE, Kanagawa-ken (JP); Daisuke AJITOMI, Kanagawa-ken (JP); Naoki ESAKA, Kanagawa-ken (JP); Hiroyuki AIZU, Kanagawa-ken (JP); Kohji SAIKI, Kanagawa-ken (JP)

(73) Assignee: KABUSHIKI KAISHA TOSHIBA, Tokyo (JP)

(21) Appl. No.: 13/422,347

(22) Filed: Mar. 16, 2012

Related U.S. Application Data
(63) Continuation of application No. PCT/JP2009/004663, filed on Sep. 17, 2009.

(51) Int. Cl. G06F 17/30

(52) U.S. Cl. 707/736; 707/E17.005

(57) ABSTRACT

A metadata collecting device efficiently acquires metadata from one or more metadata providing devices that hold contents and metadata of the contents distributed from one or more content distribution services, and accumulates the acquired metadata. The metadata collecting device includes a cache system determining unit that determines for each service an accumulation system that accumulates the metadata, a service/metadata information accumulating unit that stores for each accumulation system accumulation system information which includes at least a start condition to start acquiring the metadata, a search condition to select the metadata to be acquired, and a finish condition to finish acquiring the metadata, and a metadata acquiring/update requesting unit that acquires the metadata according to the accumulation system information.

### CROSS-REFERENCE TO RELATED APPLICATIONS

This application is a continuation application of PCT application Serial No. PCT/JP2009/004663, filed on Sep. 17, 2009, the entire contents of which are incorporated herein by reference.

### FIELD

Embodiments described herein generally relate to a metadata collecting device that efficiently collects and accumulates metadata of contents and the like, and efficiently updates the accumulated (cached) metadata.

### BACKGROUND

In recent years, multimedia content distribution services using Internet Protocol (IP) communications are operated by various communication and service providers in the context of distribution of broadband. A large variety of services are provided ranging from a video distribution service of low resolution for cell-phones to a video distribution service of high resolution in High Definition (HD) quality for digital televisions.

A Video On Demand (VoD) video distribution service for distributing videos by unicast is available as one of multimedia content distribution services. This service can be broadly classified into a service that uses a portal service and a service that uses Electronic Content Guide (ECG), as navigation of search and selection of content.

The portal service is for performing navigation in a WEB browser that is provided by a service provider. A user accesses a WEB page called portal that is provided by each service provider, searches and selects desired content, and receives a video stream. In the portal service, contents are searched on all servers, and the portal service provides a searched result to the user on the WEB page.

On the other hand, ECG is an application on a receiving device. ECG provides an interface to the user for the user to acquire program information called metadata, select desired one from many metadata, and search, display, select, view, and purchase a service. The service using ECG stores in advance metadata that becomes a core necessary for navigation in the receiving device, and uses the service. The service using ECG has an advantage in that it operates faster than the portal service, because the portal service requests the user to acquire screen configuration information of a service site. According to the service using ECG, a screen design can be determined at a receiver side, and operation and screen transition by using a receiver remote control that cannot be achieved by browser can be performed.

Further, the service using ECG collects metadata from plural services, merges the collected metadata, and provides merged metadata to the user, and therefore can achieve multiservice navigation. An example of a system that achieves this multiservice navigation is disclosed in Japanese Patent Application Laid-Open No. 2004-102767.

According to Japanese Patent Application Laid-Open No. 2004-102767, a metadata collecting device collects and caches metadata from plural metadata providing devices in advance. When a receiving device performs a metadata acquisition request to the metadata collecting device, the metadata collecting device returns metadata held by these metadata providing devices to the receiving device in a consolidated format.

According to Japanese Patent Application Laid-Open No. 2004-102767, when there is a variance between cached metadata and metadata held by the metadata providing devices, it is necessary to acquire metadata again from the metadata providing devices. Therefore, a hit rate of cached metadata becomes low in a service in which metadata are frequently updated. Consequently, metadata needs to be collected from the metadata providing devices again, and it takes time until displaying content in the receiving unit.

Further, according to Japanese Patent Application Laid-Open No. 2004-102767, a mode of arranging a metadata collecting device at a server side is assumed. Therefore, contents accumulated in an in-house HDD recorder cannot be searched.

Further, because all data are acquired from metadata collecting devices, the metadata cannot be accommodated in a consumer appliance such as a digital television having a large constraint in a hard disk capacity, memory capacity and the like.

### BRIEF DESCRIPTION OF THE DRAWINGS

FIG. 1 is a block diagram showing a configuration of a content distribution system to which a metadata collecting device is applied according to a first embodiment of the invention;

FIG. 2 is a block diagram showing a configuration of the metadata collecting device according to the first embodiment;

FIG. 3 is a flowchart showing an example of operation at an activation time of the metadata collecting device according to the first embodiment;

FIG. 4 is a flowchart showing another example of operation at an activation time of the metadata collecting device according to the first embodiment;

FIG. 5 is a flowchart showing an example of operation at an update time of cached metadata according to the first embodiment;

FIG. 6 is a flowchart showing an example of operation at a delete time of cached metadata according to the first embodiment;

FIG. 7 is a flowchart showing operation when a metadata acquisition request occurs from a user according to the first embodiment;

FIG. 8 shows an example of service information accumulated in a service/metadata information accumulating unit according to the first embodiment;

FIG. 9 shows an example of service information accumulated in a service/metadata information accumulating unit according to the first embodiment;

FIG. 10 shows an example of a content search screen according to the first embodiment;

FIG. 11 shows an example of a search result display screen according to the first embodiment;

FIG. 12 shows an example of a service list according to the first embodiment;

FIG. 13 is a block diagram showing a configuration of a metadata collecting device according to a second embodiment of the invention;

FIG. 14 is a flowchart showing an example of operation at a activation time of the metadata collecting device according to the second embodiment;

FIG. 15 shows an example of service information accumulated in a service/metadata information accumulating unit according to the second embodiment;

FIG. 16 shows an example of genre/keyword registered information accumulated in a genre/keyword registered information accumulating unit according to the second embodiment; and

FIG. 17 shows an example of genre/keyword converted information accumulated in a genre/keyword converted information accumulating unit according to the second embodiment.

### DETAILED DESCRIPTION

In view of the above circumstances, an aspect of the embodiments provides a metadata collecting device that acquires metadata from one or more metadata providing devices that hold contents and metadata of the contents distributed from one or more content distribution services, and accumulates the acquired metadata, in a content distribution service. The metadata collecting device includes an accumulation system determining unit that determines an accumulation system for each service from among plural accumulation systems that accumulate the metadata, a storage unit that stores accumulation system information for each accumulation system wherein the information is uniquely determined from a start condition to start acquiring the metadata, a search condition to select the metadata to be acquired, and a finish condition to finish acquiring the metadata, an acquiring unit that acquires corresponding one of the metadata following the accumulation system information for each service, and an accumulating unit that stores the acquired data.

According to the aspect of the embodiments it is allowed to efficiently collect and accumulate metadata of contents for each content distribution service.

Embodiments of the invention are explained in detail below with reference to drawings.

### First Embodiment

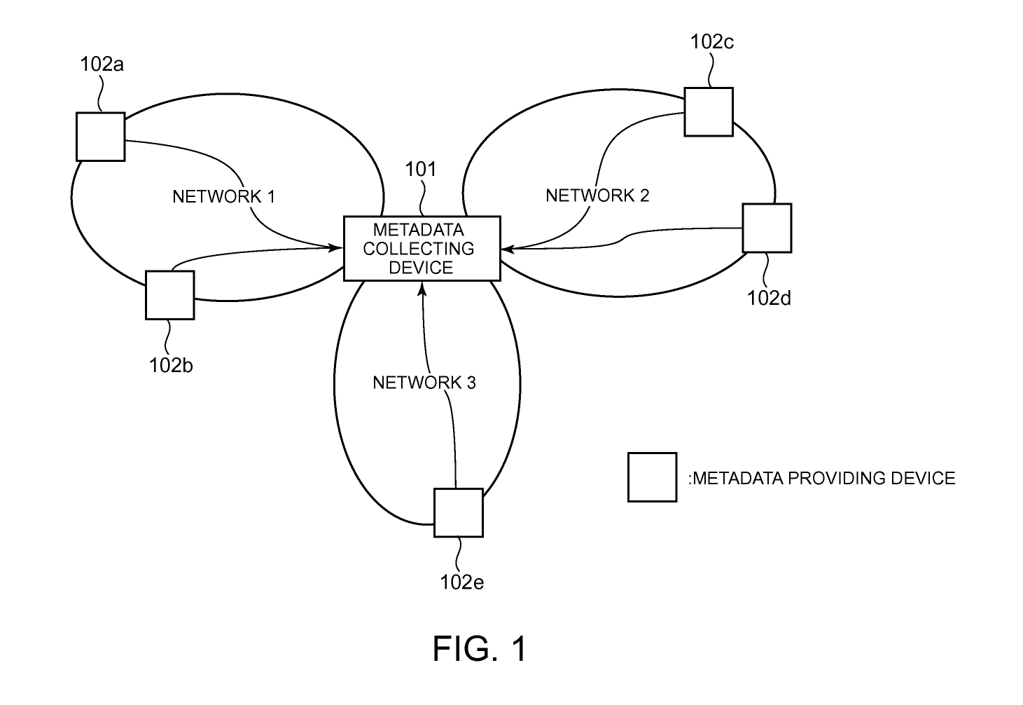

FIG. 1 is an overall view of a content distribution system to which a metadata collecting device according to a first embodiment is applied.

A metadata collecting device 101 according to the embodiment is connected to plural networks 1 to 3. One or more metadata providing devices 102a to 102e are connected to each of the networks 1 to 3.

Outlines of the metadata providing devices 102a to 102e, the metadata collecting device 101, and the networks 1 to 3 are explained first, and thereafter, the metadata collecting device 101 is explained in detail.

The metadata providing devices 102a to 102e provide metadata of contents relevant to corresponding content distribution services, respectively. The metadata is not content itself, but indicates attribute information of the content. When the content is video data, audio data, a WEB page, etc, the metadata is a title (an identifier), detailed information, date and time of generation, a content location, etc. A metadata description format can be a standard specification or a unique format of each service.

The metadata providing devices 102a to 102e are meta servers that are operated by content distribution service providers, content holding machines such as HDD recorders, and local storages that are connected to the metadata collecting device 101.

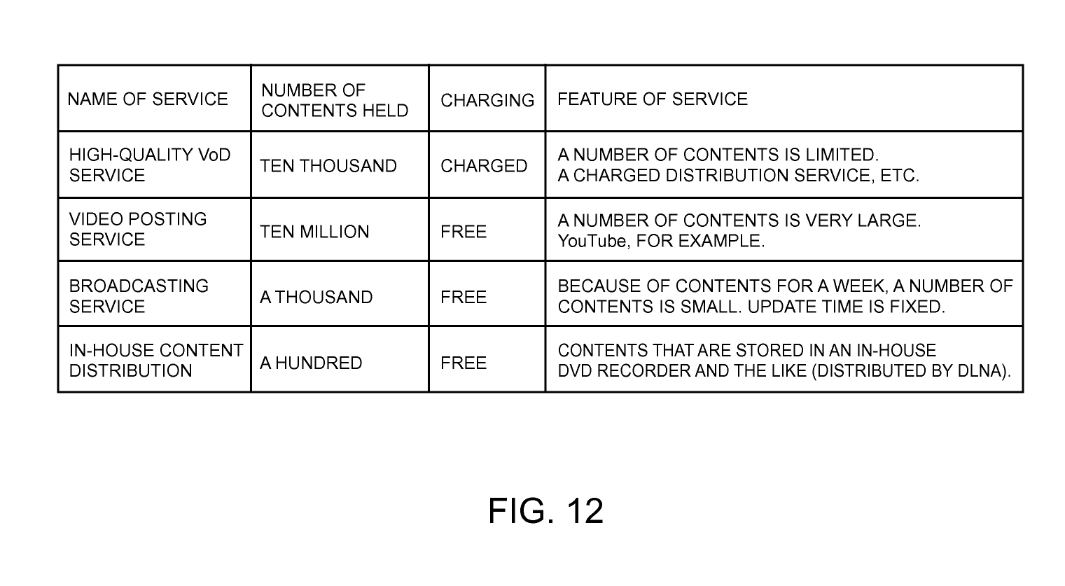

FIG. 12 shows an example of content distribution services. For example, the metadata providing device 102a provides metadata of content that is distributed by a high-quality VoD service, and the metadata providing device 102b provides metadata that is distributed by a video posting service. As explained above, there are various services ranging from a service that provides a very large number of contents to a service that provides a limited number of contents. These services have the following differences.

A holding number of contents is large/small.

Charged /free of service

In-house contents/contents on an external network

Update frequency is low/high.

The metadata collecting device 101 is a device that collects and manages metadata from the metadata providing devices 102a to 102e. The metadata collecting device 101 is a device such as a television and a personal computer (PC) that has a video display function, or a device that collects and manages metadata on behalf of this device (a television, a PC, or the like). In the metadata collecting device 101, a metadata collection application called an ECG application and the like is being executed, and this application collects and manages the metadata. In the embodiment, the metadata collecting device 101 has a characteristic in that the device reduces required time to collect metadata from the metadata providing devices 102a to 102e, by accumulating as many metadata as possible on the metadata collecting device 101. With this arrangement, a high-speed navigation function is achieved for the user to search and view video contents from plural content distribution services, in a consumer appliance such as a digital television.

The networks 1 to 3 are mutually different networks. The different networks are the following networks.

Different networks that are operated by different network providers

Different networks that are operated by the same network provider

Local area networks

The different networks that are operated by different network providers are a network 1 that is operated by a network provider A and a network 2 that is operated by a network provider B, for example. Physically different networks are handled as separate networks in this way.

The different networks that are operated by the same network provider are networks that the same network provider operates as different networks according to service qualities and the like. For example, the network 1 is a quality-managed network, and the network 2 is a best-effort network that is not quality-managed. Alternatively, the network 1 may be an IPv6 network, and the network 2 may be an IPv4 network. In this way, physically or logically different networks are handled as separate networks.

The local area network is a home network that is closed in a home, for example. In this way, a home network and an external network are handled as separate networks.

The metadata collecting device 101 is explained in detail below.

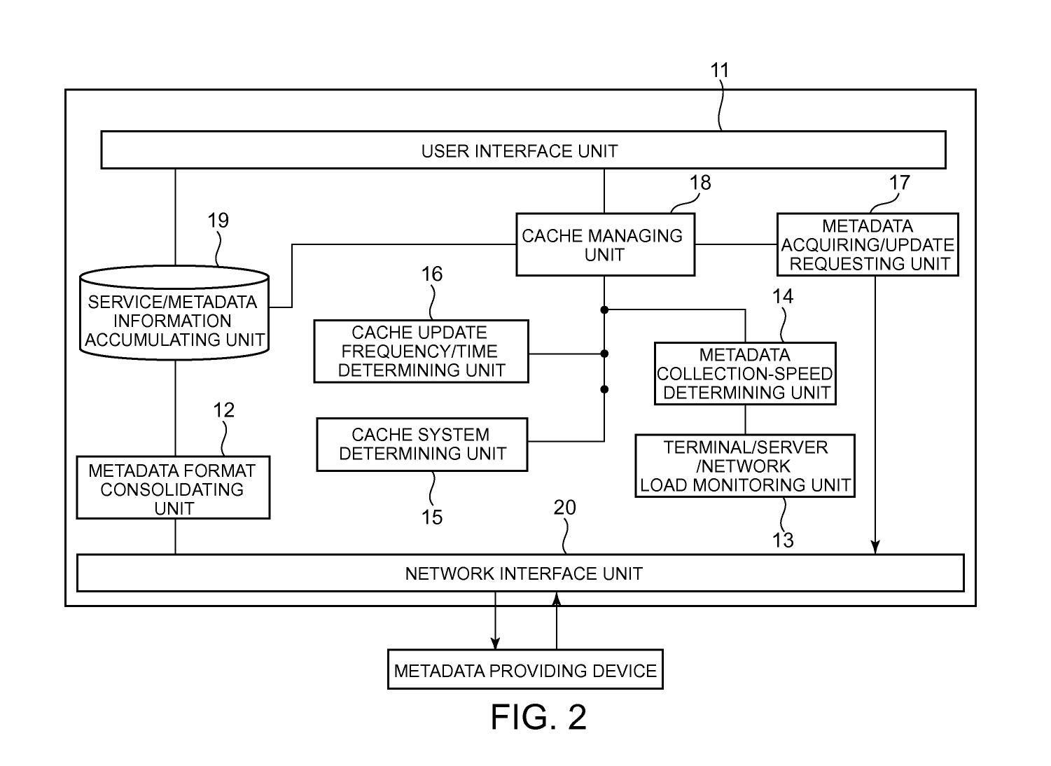

FIG. 2 is a functional block diagram of a metadata collecting device. Each functional block is explained below.

In the embodiment, a cache system determining unit 15 is an accumulation system determining unit that determines a cache system that stores metadata for each service. A service/metadata information accumulating unit 19 is a storage unit that stores a start condition to acquire metadata, a search condition to select metadata to be acquired, and a finish condition to finish acquisition of metadata for each cache system, and that further accumulates the acquired metadata. A cache managing unit 18 and a metadata acquiring/update requesting unit 17 are acquiring units that manage the start condition, the search condition, and the finish condition described above, and update of the accumulated metadata, and that acquire metadata from a network.

### [User Interface Unit 11]

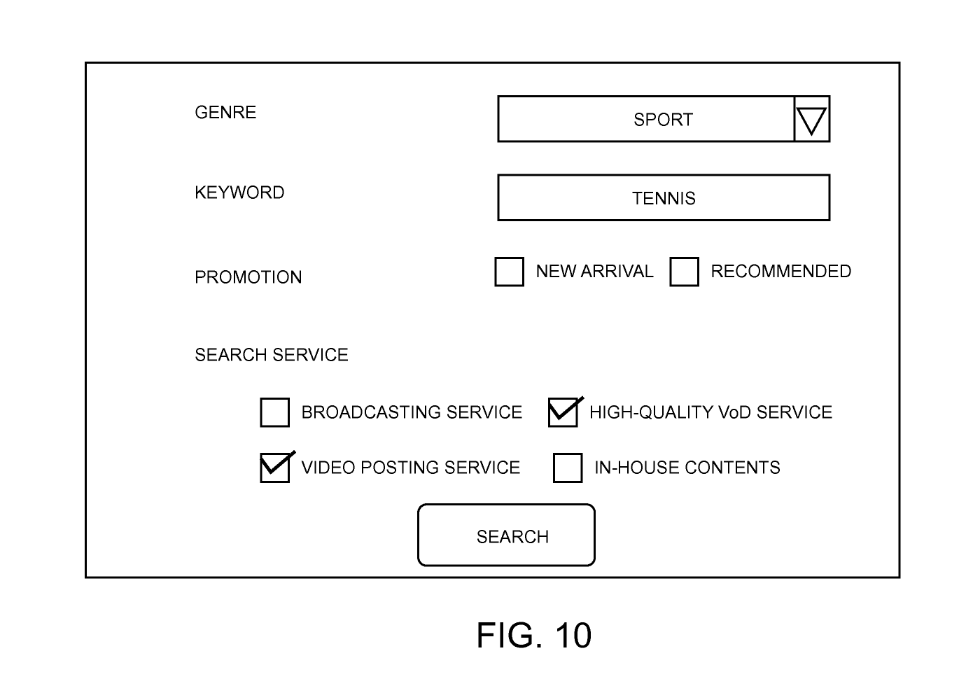

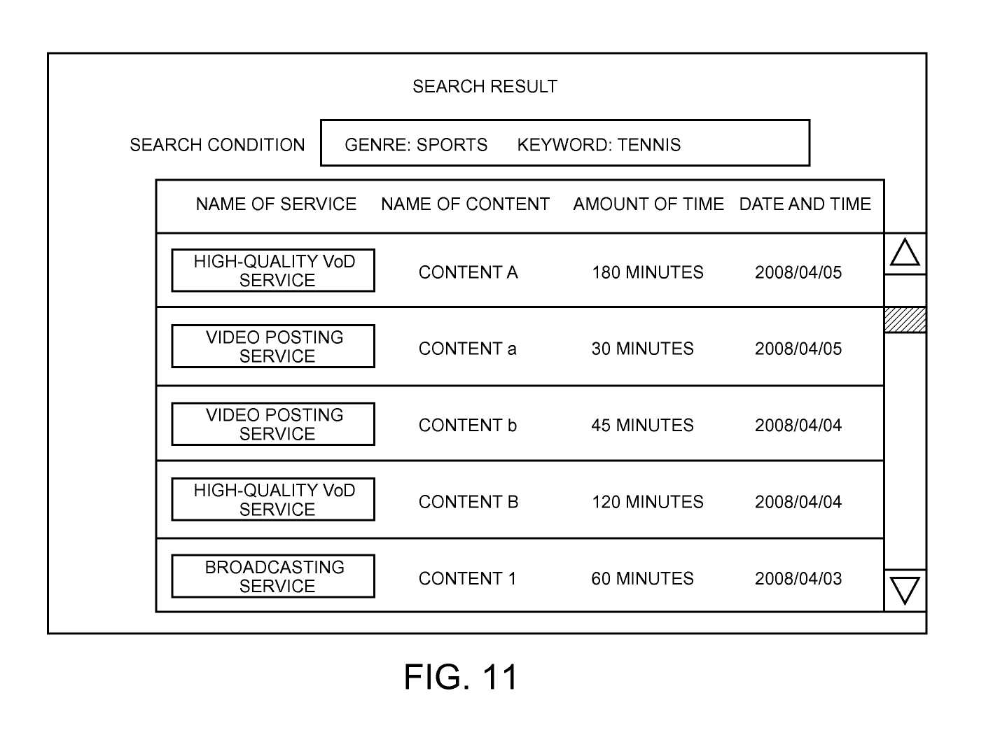

A user interface unit 11 is an input interface for the user to input a search condition of content and a service to be searched at the time of searching desired content. The user interface unit 11 also provides an output interface for displaying a content list (a list of titles and the like) as a search result. FIG. 10 shows an example of a content search screen for inputting a search condition of content and a service to be searched. FIG. 11 shows an example of a search result display screen that contains a list of searched content.

### [Network Interface Unit 20]

A network interface unit 20 is an interface unit for transmitting/receiving information to/from the metadata providing devices 102a to 102e via the networks 1 to 3. Specifically, the network interface unit 20 is an interface unit to transmit a metadata acquisition request packet to the metadata providing devices 102a to 102e, and receive a metadata packet from the metadata providing devices 102a to 102e.

### [Metadata Format Consolidating Unit 12]

A metadata format consolidating unit 12 consolidates formats of metadata collected from the plural metadata providing devices 102a to 102e, and accumulates the metadata of consolidated formats in the service/metadata information accumulating unit 19. That is, the metadata format consolidating unit 12 accumulates the metadata collected for each service, in the service/metadata information accumulating unit 19, by absorbing a difference of metadata formats.

### [Terminal/Server/Network Load Monitoring Unit 13]

A terminal/server/network load monitoring unit 13 monitors CPU load of the metadata collecting device 101, a state of other application being executed in the metadata collecting device 101, or influence of outer disturbance such as network load and server load. The monitoring of a state of other application corresponds to monitoring of an operation state of a video reception application or a video display application of which operation receives a large influence from collection of metadata, for example.

### [Metadata Collection-Speed Determining Unit 14]

A metadata collection-speed determining unit 14 determines a metadata collection speed according to various load states monitored by the terminal/server/network load monitoring unit 13. The metadata collection speed is a number of metadata collected per one request, or a metadata collection speed per unit time (a metadata acquisition number per one minute, for example). Hereafter, the metadata collection speed is defined as the number of metadata collected per one request.

The metadata collection-speed determining unit 14 determines a metadata collection speed based on the following indicators.

(1) CPU load of the own terminal, an activation state of other application

(2) Network load

(3) Server load

How a metadata collection speed for each load is determined is explained below.

### (1) CPU Load of the Own Terminal, an Activation State of Other Application

When CPU load of the own terminal is high or when other application (a video reception application, a video display application, for example) is activated, the activated application has a possibility of being influenced by metadata collection. Therefore, metadata are collected by taking time, by reducing a metadata acquisition number per one request or by re-acquisition after a certain amount of time elapsed. On the other hand, when CPU load is low or when other application is not activated, influence of metadata collection is small. Therefore, metadata are collected in short time by increasing a metadata collection number per one request.

For example, a metadata collection speed is set as five metadata per one request, when the video display application is activated. Alternatively, a metadata collection speed is set as 100 metadata per one request, when the video display application is not activated. With this arrangement, metadata can be collected while minimizing an influence to the video display application with a large impact by metadata collection.

### (2) Network Load

When there are few usable network zones, or when a packet loss occurs frequently, or when jitter of a packet is large, there is a possibility that network load is high. When a large amount of metadata is collected in this state, a situation has a possibility of being more aggravated by convergence and the like. To avoid this aggravation, a metadata collection number per one request is reduced, when network load is considered to be large due to a small number of usable network zones, or due to frequent occurrence of a packet loss, or due to large jitter. Alternatively, metadata are collected by taking time by re-acquisition after a certain amount of time elapsed. On the other hand, when network load is considered to be small, metadata are collected in short time by increasing a metadata collection number per one request.

### (3) Server Load

When the metadata collecting device 101 collects metadata from a metadata providing device 102n (102n indicates one or plural devices of the metadata providing devices 102a to 102e), a processing delay that occurs in the metadata providing device 102n gives a large influence to a metadata collection speed. For example, when load of the metadata providing device 102n is very high, the metadata collecting device 101 receives no response from the metadata providing device 102n even when the metadata collecting device 101 requests the metadata providing device 102n for metadata. Therefore, problems arise such as occurrence of a request timeout and delayed display of metadata by the metadata collecting device 101 due to the request timeout. To avoid these problems, a metadata collection number per one request is reduced, when load of the metadata providing device 102n is considered to be high judging from a speed of response from the metadata providing device 102n or from time required to receive transmitted metadata. Alternatively, metadata are collected by taking time by re-acquisition after a certain amount of time elapsed. On the other hand, when load of the metadata providing device 102n is considered to be small, metadata are collected in short time by increasing a metadata collection number per one request.

As described above, the metadata collection-speed determining unit 14 determines a metadata collection speed by considering load of the terminals, the server, and the network explained in (1) to (3). With this arrangement, metadata can be collected efficiently and without giving influence to other applications.

### [Service/Metadata Information Accumulating Unit (Accumulating Unit, Storage Unit) 19]

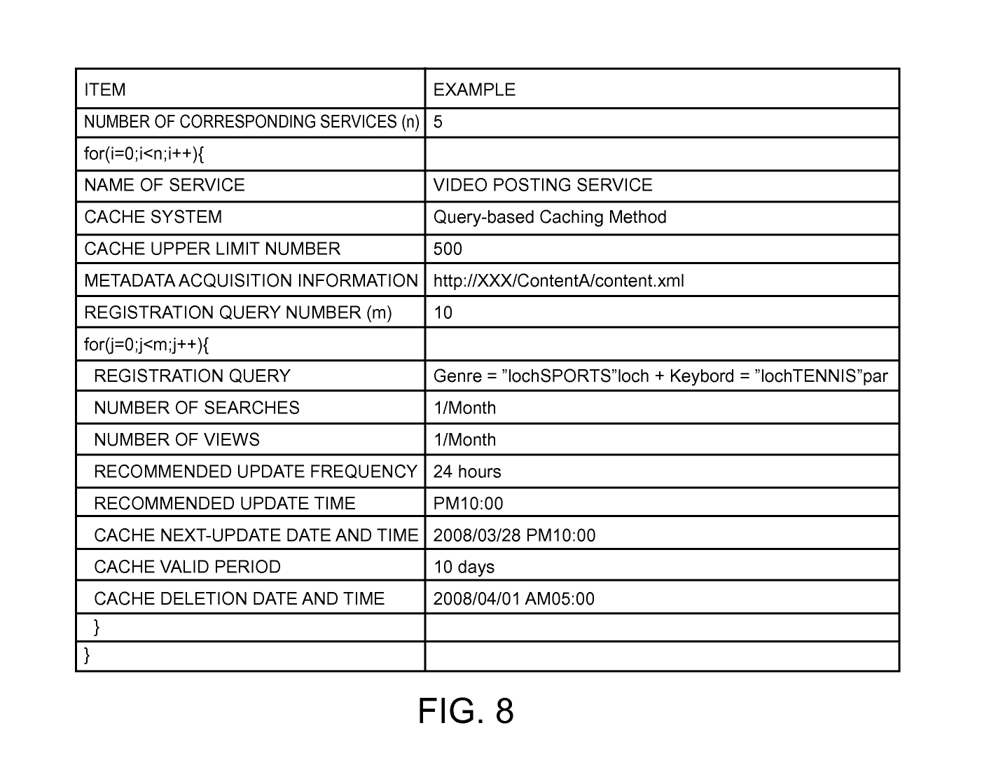

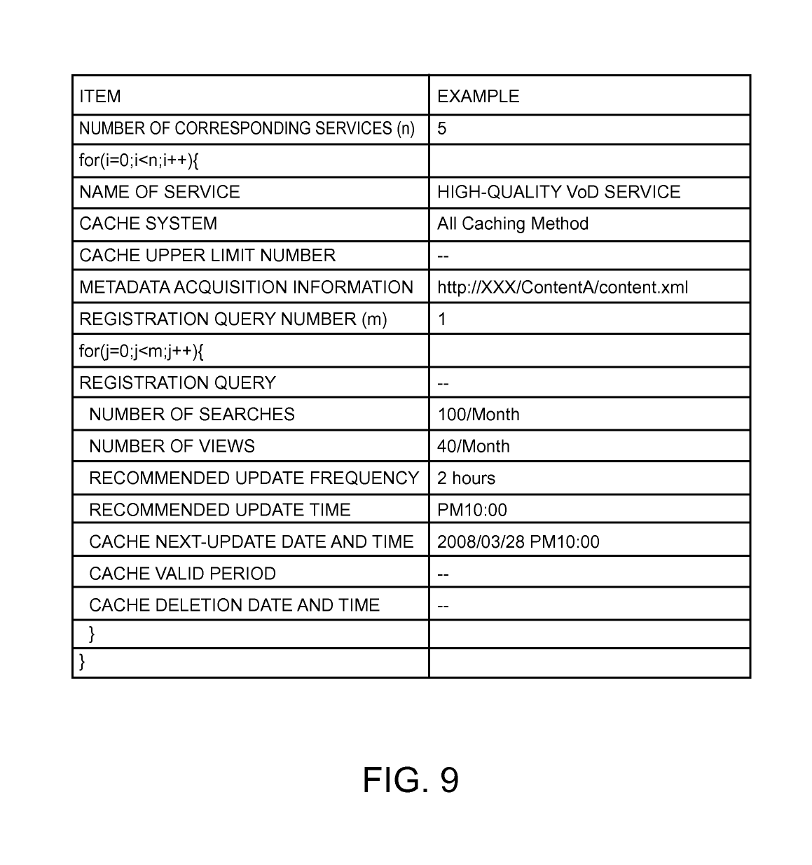

The service/metadata information accumulating unit 19 is an accumulating unit that accumulates metadata collected from the metadata providing devices 102a to 102e. Further, the service/metadata information accumulating unit 19 accumulates service information that is set for each service as shown in FIGS. 8 and 9. The service information is described in detail below. The service information contains a cache system (an accumulation system) determined by the cache system determining unit (an accumulation system determining unit) 15. The service/metadata information accumulating unit 19 also has a role of a storage unit that stores a cache system (an accumulation system) for each service. The service/metadata information accumulating unit 19 is constituted by a hard disk or a nonvolatile memory, for example. The service information shown in FIGS. 8 and 9 contains the following items.

Number of corresponding services

Name of corresponding service

Cache system

Cache upper limit number

Metadata acquisition information

Registration query number

Registration query

Number of searches

Number of views

Recommended update frequency (cache update frequency)

Recommended update time (cache update time)

Cache next-update date and time

Cache valid period

Cache deletion date and time

“Number of corresponding services” indicates a number of registered services. Five services are registered in the example of FIGS. 8 and 9. “Video posting service” as one of the five services is shown in FIG. 8, and “High-quality VoD service” as another one of the five services is shown in FIG. 9.

“Name of corresponding service” indicates a name of a registered service, that is, a name of a service corresponding to a metadata collection application such as ECG.

“Cache system” indicates a cache system (an accumulation system) that is determined by the cache system determining unit 15 (an accumulation system determining unit) 15 described later. The cache system includes a Query-based Caching Method (a search-based accumulation system) and an All Caching Method (a prior accumulation system). That is, the All Caching Method (a prior accumulation system) is a system that caches in advance all metadata held (provided) by a service. The Query-based Caching Method (a search-based accumulation system) is a system that caches only a few highly-ranked number of metadata or all metadata for a search condition (a search formula) that is searched, each time when search is performed.

“Cache upper limit number” indicates an upper limit value of a cached number for each search, and metadata are acquired and cached up to this upper limit number, in the case of the Query-based Caching Method (a search-based accumulation system).

“Metadata acquisition information” indicates information that becomes necessary at the time of acquiring metadata from the metadata providing device 102n. For example, “Metadata acquisition information” corresponds to metadata acquisition URL that is provided by the metadata providing device 102n, and metadata acquisition API that is prepared by the metadata acquisition application such as the ECG application to acquire metadata of each service.

“Registration query” indicates a search condition that was searched in the past. However, a search condition that was searched is registered as a registration query, only when a cache system is the Query-based Caching Method (a search-based accumulation system), as described later. The search condition is a combination of genre and a keyword, such as “Genre: Sports, Keyword: Tennis”, for example. The combination is not limited to this, and can be a combination of promotion information (recommendation, a new arrival, etc.).

“Registration query number” indicates a number of registration queries in the case of the Query-based Caching Method (a search-based accumulation system). In the example of FIG. 8, ten registration queries are registered. A set of items “Registration query” to “Cache deletion date and time” is prepared for each registration query. Because ten registration queries are present in the example of FIG. 8, ten sets of “Registration query” to “Cache deletion date and time” are prepared. However, “1” is fixed to a number of registration queries in the case of the All Caching Method (a prior accumulation system).

“Number of searches” indicates a number of searches for each registration query or each service. “Number of searches” indicates a number of searches for each registration query when a cache system is the Query-based Caching Method (a search-based accumulation system), and indicates a number of searches for each service when a cache system is the All Caching Method (a prior accumulation system).

“Number of views” indicates a number of times of viewing corresponding content of each registration query or each service. For example, “number of views” becomes X, when a total number of times of viewing content following a link from metadata acquired by searching based on a certain registration query is X.

“Recommended update frequency” and “Recommended update time” indicate update frequency of cache and update time of frequency. More specifically, the recommended update frequency is an interval from the last update date and time to the next update date and time, and the recommended update time is a time zone to update cache, such as “recommended update frequency: every one hour” and “recommended update time: AM10:00”, for example. The recommended update time and the recommended update frequency may be values determined by a cache update frequency/time determining unit 16 described later, or may be registered in advance in the service/metadata information accumulating unit 19.

“Cache next-update date and time” indicates date and time when a cache is to be updated next, and is determined based on the recommended update frequency and the recommended update time by the cache managing unit 18 described later.

“Recommended update frequency” and “recommended update time” correspond to an update condition of the invention. Particularly, the recommended update frequency corresponds to an update frequency of the invention, and the recommended update time corresponds to an update time zone. Alternatively, “cache next-update date and time” corresponds to an update condition of the invention. In the explanation described later, the cache next-update date and time as an indicator that reflects the recommended update frequency and the recommended update frequency is employed for the update condition. The update condition is not limited to “recommended update frequency”, “recommended update time”, and “cache next-update date and time” described above, when the update condition determines a momentum of update of cache.

“Cache valid period” indicates a period while the cache is valid, and is determined by the cache update frequency/time determining unit 16 described later. The cache valid period is set only when a cache system is the Query-based Caching Method (a search-based accumulation system). The cache valid period is set as ten days, for example.

“Cache deletion date and time” is determined based on the last update date and time and the cache valid period by the cache managing unit 18 described later. For example, when the last update time is 2008/04/03 AM10:00, and also when the cache valid period is ten days, the cache deletion date and time becomes 2008/04/13 AM10:00.

As described above, metadata stored in the service/metadata information accumulating unit 19 is accumulated by the unit of service when a cache system is for a service of the All Caching Method (a prior accumulation system), and is stored by the unit of registration query for each service when a cache system is for a service of the Query-based Caching Method (a search-based accumulation system).

### [Cache System Determining Unit (an Accumulation System Determining Unit) 15]

The cache system determining unit (an accumulation system determining unit) 15 determines a cache system for each service registered in the service/metadata information accumulating unit 19. The cache system determined by the cache system determining unit (an accumulation system determining unit) 15 is registered in the service/metadata information accumulating unit 19 via the cache managing unit 18. The caching system selects any one of (1) and (2) described below.

### (1) The All Caching Method (a Prior Accumulation System)

This system caches in advance all metadata held (provided) by the service. After caching of all metadata is completed, only a difference is periodically updated. Metadata update is based on the cache next-update date and time that is being managed by the service/metadata information accumulating unit 19.

### (2) The Query-Based Caching Method (a Search-Based Accumulation System)

This system does not cache in advance metadata that are held (provided) by the service, but caches only highly-ranked number of metadata for each search condition (a search formula) that is searched. The highly-ranked number of metadata are determined for each service in advance, such as 500, for example, and a request is made to the metadata providing device 102n to transmit highly-ranked number of metadata (500) as a maximum. When metadata transmitted from the metadata providing device 102n exceeds the highly-ranked number of metadata as a result of requesting the metadata providing device 102n to transmit all metadata that match a search condition, it can be arranged such that only the highly-ranked number of metadata are selected from among these metadata. In this case, a selection standard can be arbitrary, and first acquired highly-ranked number of metadata can be selected, for example. When a priority is attached to metadata, highly-ranked number of metadata can be selected from metadata in the order from higher priorities.

In the system, metadata that match a search condition are collected from the metadata providing device 102n only at the first search time. Thereafter, metadata are periodically updated at update timing in this search unit (that is, a query unit). In updating, metadata of each registration query (a search condition) are acquired again up to an upper limit number, by deleting cache. Alternatively, when only a difference can be acquired, only the difference is acquired again, without once clearing cache. However, a cache number of each registration query is up to the upper limit number.

Metadata update (cache update) is performed based on the cache next-update date and time that is registered in the service/metadata information accumulating unit 19. Deletion of cache is performed based on the cache deletion date and time that is registered in the service/metadata information accumulating unit 19. In the system, a cache valid period is provided, and the cache is cleared after this time elapsed. Although only the highly-ranked metadata are cached in the above explanation, it can be arranged such that all metadata that match a search condition are cached.

The cache system determining unit (an accumulation system determining unit) 15 determines a cache system according to one of the following indicators (A) to (C). The cache system determining unit (an accumulation system determining unit) 15 decides by prioritizing capacity of the service/metadata information accumulating unit 19, that is, hard disk or memory capacity, regardless of any indicator being used.

### (A) Manual

The user determines a cache system for each service. For example, the user determines a cache system in a pop-up screen displayed.

### (B) Pre-Configure

A cache system corresponding to each service is registered in advance in the service/metadata information accumulating unit 19. For example, the All Caching Method (a prior accumulation system) is registered in advance for a high-quality VoD video service, because a number of contents is limited in this service, and the Query-based Caching Method (a search-based accumulation system) is registered in advance for a video posting service, because a number of contents is very large in this service.

### (C) Auto

A cache system for each service is automatically decided. Decision is based on any of the following decision standards. However, the decision is not limited to these decision standards, and any decision standard may be used as long as a cache system can be decided.

The All Caching Method (a prior accumulation system) is determined when a total holding number of contents (a total number of metadata) can be acquired from a service and also when a total number of contents (a total number of metadata) is equal to or smaller than a certain threshold value. In other cases, the Query-based Caching Method (a search-based accumulation system) is determined. The threshold value can be a fixed quantity or can be determined based on capacity of a hard disk.

A cache system is decided according to a kind or quality of a network in a network unit, not for each service. For example, the All Caching Method (a prior accumulation system) is determined for a service provided by the metadata providing device 102n on a home network or a quality-managed network. The Query-based Caching Method (a search-based accumulation system) is determined for a service provided by the metadata providing device 102n on the Internet. The All Caching Method (a prior accumulation system) is determined for a network in which contents are distributed by Digital Living Network Alliance (DLNA), and the Query-based Caching Method (a search-based accumulation system) is determined for other networks.

A cache system is decided based on a kind of service. For example, the All Caching Method (a prior accumulation system) is determined, for a charged service, and the Query-based Caching Method (a search-based accumulation system) is determined for a free service.

A cache system is decided based on update frequency of metadata. Because update frequency of metadata is also closely linked to a total number of metadata, a service for which update frequency of metadata is low is regarded to have a small total number of contents. For example, because a service of which update frequency is low has a small number of cache update, the All Caching Method (a prior accumulation system) is determined for this service. The Query-based Caching Method (a search-based accumulation system) is determined for a service of which cache update is frequent.

### [Cache Update Frequency/Time Determining Unit 16]

The cache update frequency/time determining unit 16 determines recommended update frequency and recommended update time of cache and a cache valid period, by unit of update (a service unit or a registration query unit) according to a cache system, based on an instruction from the cache managing unit 18, and registers determined results in the service/metadata information accumulating unit 19. The recommended update frequency, the recommended update time, and the cache valid period may be registered in advance in the service/metadata information accumulating unit 19. The recommended update frequency corresponds to update frequency of the invention, and the recommended update time corresponds to an update time zone of the invention.

A cache update unit is different depending on a cache system. The All Caching Method (a prior accumulation system) is updated by unit of service, and the Query-based Caching Method (a search-based accumulation system) is updated by unit of registration query. Cache is deleted only when a cache system is the Query-based Caching Method (a search-based accumulation system), and a cache valid period is registered in the case of only the Query-based Caching Method (a search-based accumulation system).

The cache update frequency/time determining unit 16 determines recommended update frequency, recommended update time, and a cache valid period, by the following methods.

### (A) Recommended Update Frequency

Recommended update frequency is determined based on the number of views or the number of searches registered in the service/metadata information accumulating unit 19. Recommended update frequency is set high for a case of a large number of views or a large number of searches. On the other hand, recommended update frequency is set low for a case of a small number of views or a small number of searches. Recommended update frequency is determined according to a number of views, such as “everyday when a number of views is equal to or smaller than five; at every 12 hours when a number of views is six to ten; at every six hours when a number of views is equal to or larger than 11”, for example. Recommended update frequency may be registered in advance in the service/metadata information accumulating unit 19, without using the cache update frequency/time determining unit 16. In this case, preferably, content to be displayed on a top screen at an activation time of the ECG application is always kept in a latest state. Therefore, recommended update frequency is set high for a service having such content or for a registration query related to metadata of this content.

### (B) Recommended Update Time

Recommended update time is determined based on an increase number of a number of metadata provided by the metadata providing device 102n for each unit time. For example, a total number of metadata is acquired from the metadata providing device 102n for each unit time. When an increase of a total number of metadata varies like “10 o'clock: 10 metadata, 14 o'clock: 10 metadata, 18 o'clock: 20 metadata, 22 o'clock: 100 metadata”, recommended update time is determined as 22 o'clock, for example.

Recommended update time may be registered in advance in the service/metadata information accumulating unit 19, without using the cache update frequency/time determining unit 16. In this case, regarding a service for which it is known that update is frequently performed at a specific time, this update time is registered in advance as recommended update time. For example, when it is known in advance that metadata is updated at break of the day such as a broadcasting service, the break of the day is registered as recommended update time.

### (C) Cache Valid Period

A cache valid period is set according to a number of searches or a number of views. For example, a cache valid period is set according to a number of views or a number of searches, such as “three days when a number of views is equal to or smaller than three; ten days when a number of views is between six and ten; and 20 days when a number of views equal to or larger than 11”.

### [Metadata Acquiring/Update Requesting Unit (Acquiring Unit) 17]

The metadata acquiring/update requesting unit 17 is an acquiring unit that requests the metadata providing device 102n to acquire metadata by receiving a metadata acquisition request from the cache managing unit 18. A start condition to acquire metadata, a search condition, and a finish condition are managed by the cache managing unit 18 described later, and the cache managing unit 18 also partially functions as the acquiring unit. A metadata collection speed, a metadata acquisition number, and service information (metadata acquisition information, for example) are supplied from the cache managing unit 18. The metadata acquiring/update requesting unit 17 acquires metadata based on these pieces of information.

The metadata collection speed is assumed to be acquired each time when a metadata acquisition request is made to the metadata providing device 102n. An example of behavior for the case where information of a metadata collection speed is 100 metadata per one request, a metadata acquisition number is 500, and service information is metadata acquisition URL of the metadata providing device is delivered to the metadata acquiring/update requesting unit 17 is explained below.

In making the next request to the metadata providing device 102n after acquiring 100 metadata at a first request, a metadata collection speed is acquired again. In this case, when the metadata collection speed is changed to ten metadata due to a phenomenon of a rapid increase of CPU load for example, metadata are acquired according to this acquisition speed. Metadata are acquired up to the total acquisition number of metadata by repeating the above operation.

### [Cache Managing Unit 18]

The cache managing unit 18 manages a start condition to acquire metadata, a search condition, a finish condition, and update of the service/metadata information accumulating unit (an accumulating unit) 19, and functions as an acquiring unit, together with the metadata acquiring/update requesting unit 17. Details are described below.

The cache managing unit 18 confirms whether a cache system is already registered for each service that is registered in the service/metadata information accumulating unit 19. When a cache system is not yet registered for a certain service, the cache managing unit 18 requests the cache system determining unit 15 to determine a cache system. The cache managing unit 18 registers the cache system determined by the cache system determining unit 15 into the service/metadata information accumulating unit 19.

The cache managing unit 18 performs the following process at only a first time to a service for which the All Caching Method (a prior accumulation system) is registered. That is, the cache managing unit 18 acquires all metadata held by the metadata providing device 102n from the metadata providing device 102n that are relevant to this service, and stores the acquired metadata in the service/metadata information accumulating unit 19 with associating the acquired metadata to this service.

In requesting acquisition of metadata, the cache managing unit 18 acquires a metadata collection speed from the metadata collection-speed determining unit 14, and assigns the metadata collection speed to the metadata acquiring/update requesting unit 17 together with a service to be searched. The cache managing unit 18 decides a cache system of the service to be searched, when there is a search query (a query that assigns a search condition and a service to be searched) from the user interface unit 11.

In the case of the All Caching Method (a prior accumulation system), the cache managing unit 18 searches metadata that matches a search condition based on metadata of a service to be searched acquired in advance, and displays detected metadata via the user interface unit 11.

In the caser of the Query-based Caching Method (a search-based accumulation system), the cache managing unit 18 decides whether a registration query that matches a search condition is present. When a registration query that matches a search condition is present, the cache managing unit 18 acquires metadata corresponding to the registration query from the service/metadata information accumulating unit 19, and displays the metadata via the user interface unit 11. When a registration query that matches a search condition is not present, the cache managing unit 18 requests the metadata acquiring/update requesting unit 17 to acquire metadata, and displays acquired metadata via the user interface unit 11. The cache managing unit 18 stores acquired metadata into the service/metadata information accumulating unit 19, by associating with the acquired metadata to a search condition (a registration query) in a service to be searched. In requesting acquisition of metadata, the cache managing unit 18 assigns a service to be searched, a search condition, and a metadata collection number, acquires a metadata collection speed from the metadata collection-speed determining unit 14, and delivers the metadata collection speed to the metadata acquiring/update requesting unit 17.

When specific metadata is assigned (when specific content is assigned) from among displayed metadata via the user interface unit 11, the cache managing unit 18 may download content corresponding to the assigned metadata from a content server (a metadata providing device may have a function of a content server) that manages the content, and may deliver the downloaded content to a content processing unit (not shown) that processes the content. In this case, an address of the content server is contained in the metadata, for example.

When there is a search query, when metadata is newly acquired, when metadata of cache is updated, or the like, the cache managing unit 18 instructs the cache update frequency/time determining unit 16 to determine recommended update frequency of cache, recommended update time, and a cache valid period. The cache managing unit 18 registers recommended update frequency of cache, recommended update time, and a cache valid period that are determined by the cache update frequency/time determining unit 16, into the service/metadata information accumulating unit 19. However, the cache managing unit 18 determines and registers the cache valid period for only the service of the Query-based Caching Method (a search-based accumulation system).

The cache managing unit 18 determines cache next-update date and time based on the cache valid period and the last update date and time, and registers the determined cache next-update date and time into the service/metadata information accumulating unit 19.

The cache managing unit 18 determines cache deletion date and time based on a cache valid period and the last update date and time, and registers the determined cache deletion date and time into the service/metadata information accumulating unit 19. In determining cache next-update date and time, the cache managing unit 18 may prioritize any one of the recommended update frequency and the recommended update time. For example, in the case of “last update time: 2008/04/03 PM4:00, recommended update frequency: two days, recommended update time: AM3:00”, cache next-update date and time may be 2008/04/05 PM4:00 or 2008/04/05 AM3:00. However, the cache managing unit 18 determines cache deletion date and time only in the case of the Query-based Caching Method (a search-based accumulation system).

The cache managing unit 18 periodically monitors service information that is being managed by the service/metadata information accumulating unit 19, and performs update/deletion of cache. That is, the cache managing unit 18 confirms cache next-update date and time (an update condition) and cache deletion date and time. The cache managing unit 18 deletes cache when the cache deletion date and time elapsed, and updates metadata when cache update date and time elapsed (when an update condition is established). However, the cache managing unit 18 deletes cache only in the case of the Query-based Caching Method (a search-based accumulation system).

### [An Operation Sequence]

An operation sequence of the metadata collecting device 101 in FIG. 2 is explained below by dividing the sequence into three parts, (1) an activation time of the metadata collecting device 101, (2) an update timing of cached metadata, and (3) occurrence of a search query from the user (the interface).

### (1) An Activation Time of the Metadata Collecting Device 101

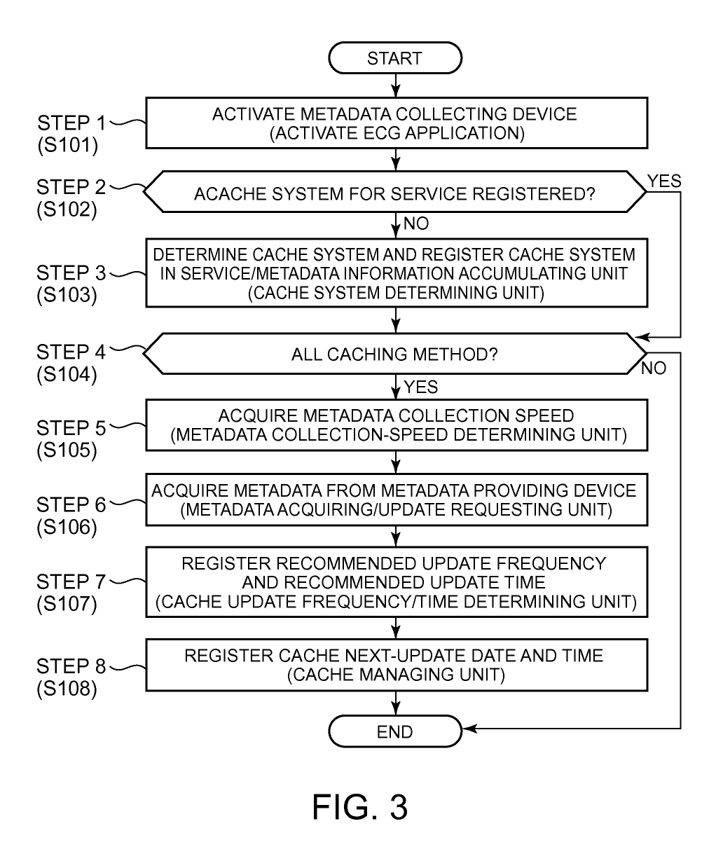

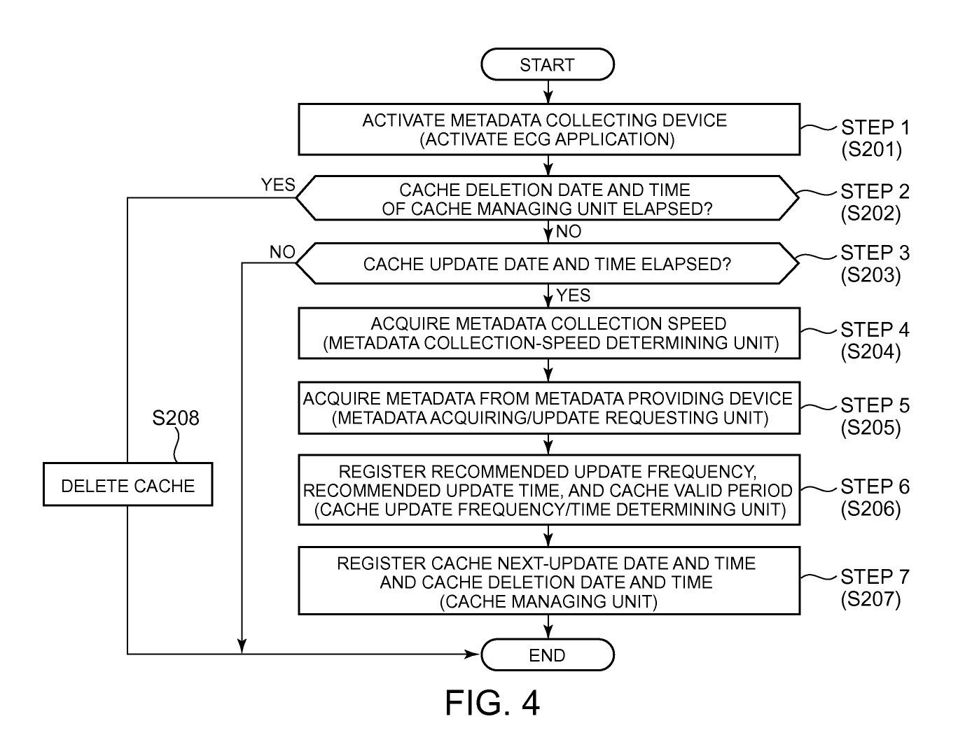

FIGS. 3 and 4 are flowcharts showing the sequence of operation performed at the activation time of the metadata collecting device 101. The activation of the metadata collecting device 101 means an activation of a metadata collection application such as ECG.

### (At a First Activation Time)

A sequence when metadata of content is not cached at all in the service/metadata information accumulating unit 19 at an activation time of the ECG application is explained below with reference to FIG. 3. Although a sequence of one service is focused in the following explanation, when plural services are present, these services can be processed in parallel sequences, or after a certain service is finished, the next service may be processed.

In Step 1, the metadata collecting device 101 is activated. That is, the ECG application is activated (S101).

In Step 2, it is confirmed whether a cache system is registered in advance for each service that is stored in the service/metadata information accumulating unit 19 (S102). When a cache system is determined in advance for each of all services (YES), the process proceeds to Step 4. When there is a service for which a cache system is not yet registered (NO), the process proceeds to Step 3.

In Step 3, the cache system determining unit 15 determines a cache system for each service, and registers a determined cache into the service/metadata information accumulating unit 19 (S103). A cache system is determined based on the decision standard described above. The All Caching Method (a prior accumulation system) or the Query-based Caching Method (a search-based accumulation system) is selected as a cache system.

In Step 4, it is determined whether a cache system of a focused service is the All Caching Method (a prior accumulation system) or not (S104). When a cache system is the All Caching Method (a prior accumulation system), the process proceeds to Step 5. When a cache system is the Query-based Caching Method (a search-based accumulation system), the process ends.

In Step 5, the metadata collection-speed determining unit 14 determines a metadata collection speed (S105).

In Step 6, the cache determining unit 18 transmits a metadata collection speed determined in Step 5, and a metadata collection number and service information (metadata acquisition information, for example), to the metadata acquiring/update requesting unit 17. The metadata acquiring/update requesting unit 17 collects metadata from the metadata providing device 102n, based on these pieces of information (S106). Because of the All Caching Method (a prior accumulation system), the metadata collection number is all metadata held by the metadata providing device 102n. Even when a cache system is the All Caching Method (a prior accumulation system), the metadata collection number is calculated in detail according to a hard disk capacity and the like, and only a calculated number of metadata can be arranged to be collected.

In Step 7, the cache update frequency/time determining unit 16 determines recommended update frequency and recommended update time, and registers the determined recommended update frequency and recommended update time into the service/metadata information accumulating unit 19 (S107).

In Step 8, the cache managing unit 18 determines cache next-update date and time based on the recommended update frequency and the recommended update time, registers the determined cache next-update date and time into the service/metadata information accumulating unit 19 (S108), and ends the sequence.

### (At Second and Subsequent Activation Times)

An operation sequence at second and subsequent activation times of the metadata collecting device 101 is explained with reference to FIG. 4. It is assumed that a cache system is already registered for each service in the service/metadata information accumulating unit 19. It is also assumed that a cache is already stored for at least a service of the All Caching Method (a prior accumulation system). This sequence is disclosed for a case where activation of the metadata collecting device 101 is linked to activation of the ECG application. This sequence is not applied when the ECG application is always activated (when the ECG application is also activated in the background during a power supply off period of the metadata collecting device). Although a sequence of one service is focused in the following explanation, when plural services are present, these services can be processed in parallel sequences, or after a certain service is finished, the next service may be processed.

As shown in FIG. 4, in step 1, the metadata collecting device 101 is activated (S201). That is, the ECG application is activated.

In Step 2, it is confirmed whether cache deletion date and time that is registered in the service/metadata information accumulating unit 19 already elapsed, for each service of the Query-based Caching Method (a search-based accumulation system) (S202). When the cache deletion date and time already elapsed (YES), cache is deleted (S208), and the sequence is finished. When the cache deletion date and time already does not elapse (NO), the process proceeds to Step 3.

In Step 3, it is confirmed whether cache update date and time that is registered in the service/metadata information accumulating unit 19 already elapsed, for each service (S203). When cache update date and time is already elapsed (YES), the process proceeds to Step 4. When cache update date and time does not elapse (NO), the sequence is finished.

In Step 4, the metadata collection-speed determining unit 14 determines a collection speed of metadata (S204).

In Step 5, the cache managing unit 18 transmits the metadata collection speed that is determined in Step 4, and a metadata collection number and service information (metadata collection information, for example), to the metadata acquiring/update requesting unit 17. The metadata acquiring/update requesting unit 17 collects metadata from the metadata providing device 102n, based on these pieces of information (S205). However, the cache managing unit 18 transmits a metadata collection number only in the case of the Query-based Caching Method (a search-based accumulation system). In collecting metadata, only a difference is collected, in the case of the All Caching Method (a prior accumulation system). In the case of the Query-based Caching Method (a search-based accumulation system), metadata of a metadata collection number (a highly-ranked number) that are requested from the cache managing unit 18 are collected from the metadata providing device.

In Step 6, the cache update frequency/time determining unit 16 determines recommended update frequency, recommended update time, and a cache valid period, and registers these pieces of information into the service/metadata information accumulating unit 19 (S206). However, the cache valid period is determined and registered in the case of only the Query-based Caching Method (a search-based accumulation system).

In Step 7, the cache managing unit 18 determines cache next-update date and time and cache deletion date and time, based on the recommended update frequency, the recommended update time, and the cache valid period, registers these pieces of information into the service/metadata information accumulating unit 19 (S207), and ends the sequence. However, the cache deletion date and time is determined and registered only in the case of the Query-based Caching Method (a search-based accumulation system).

### (2) Cache Update/Deletion Timings

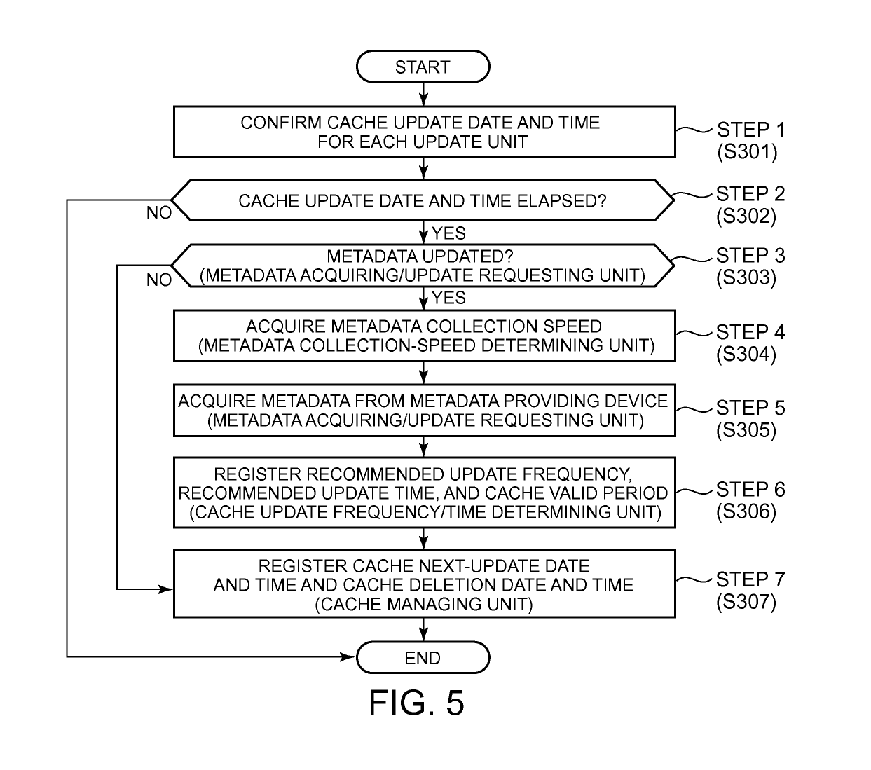

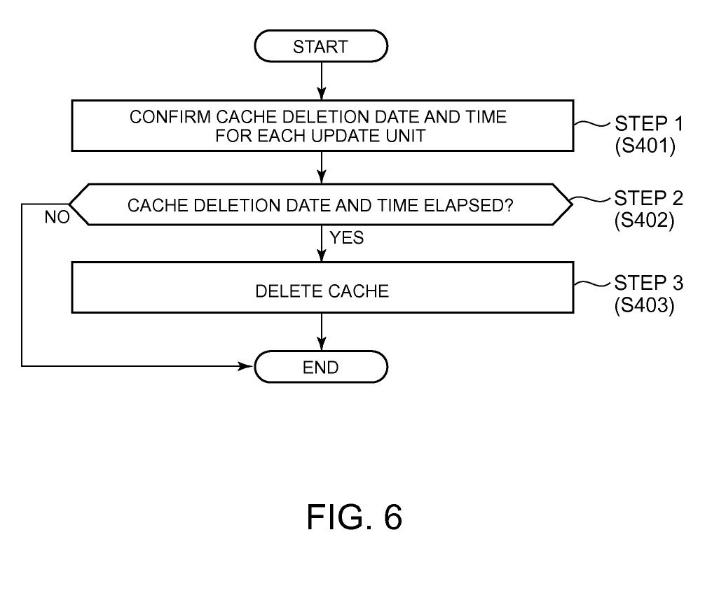

Next, an operation sequence at cache update/deletion timings is explained with reference to FIGS. 5 and 6. Although a sequence of one service is focused in the following explanation, when plural services are present, these services may be processed in parallel sequences, or after a certain service is finished, the next service may be processed.

### (Cache Update Timing)

FIG. 5 is a flowchart showing an operation sequence at cache update timing. In Step 1, cache update date and time that is registered in the service/metadata information accumulating unit 19 is confirmed, for a focused service (S301). When a cache system of the focused service is the Query-based Caching Method (a search-based accumulation system), update date and time is confirmed for each registration query. When a cache system of the focused service is the All Caching Method (a prior accumulation system), only one registered update date and time is confirmed.

In Step 2, it is confirmed whether the cache update date and time acquired in Step 1 already elapsed (S302). When the cache update date and time does not elapse (NO), the sequence is finished. On the other hand, when the cache update date and time already elapsed (YES), the process proceeds to Step 3.

In Step 3, the metadata acquiring/update requesting unit 17 confirms with the metadata providing device whether there is a metadata update by unit of update (a registration query in the case of the Query-based Caching Method (a search-based accumulation system), and a service in the case of the All Caching Method (a prior accumulation system)) (S303). When there is an update of metadata, the process proceeds to Step 4. When there is no update of metadata, the process proceeds to Step 7.

In Step 4, the metadata collection-speed determining unit 14 determines a metadata collection speed (S304).

In Step 5, metadata are collected from the metadata providing device 102n, according to the metadata collection speed determined in Step 4 and the metadata collection number. The metadata format consolidating unit 12 consolidates formats of the collected metadata, and accumulates the consolidated metadata in the service/metadata information accumulating unit 19 (S305). In the case of the All Caching Method (a prior accumulation system), only a difference is acquired, and the acquired difference is added to the service/metadata information accumulating unit 19. This difference includes not only metadata of new content but also metadata updated by the metadata providing device for already existing content. In the latter case, metadata before update that are originally present in the service/metadata information accumulating unit 19 are overwritten. In the case of the Query-based Caching Method (a search-based accumulation system), metadata of a cache upper limit number for each query are acquired, and the acquired metadata are accumulated in the service/metadata information accumulating unit 19. When metadata of the same content as that of the acquired metadata are already present in the service/metadata information accumulating unit 19, the metadata that are already present are overwritten.

In Step 6, the cache update frequency/time determining unit 16 determines recommended update frequency, recommended update time, and a cache valid period, and registers the determined information into the service/metadata information accumulating unit 19 (S306). However, the valid period is determined and registered only in the case of the Query-based Caching Method (a search-based accumulation system).

In Step 7, the cache managing unit 18 determines cache next-update date and time, based on the recommended update frequency, the recommended update time, and the cache valid period, registers the determined cache next-update date and time into the service/metadata information accumulating unit 19 (S307), and ends the sequence. However, the cache deletion date and time is determined and registered only in the case of the Query-based Caching Method (a search-based accumulation system).

### (Cache Deletion Timing)

FIG. 6 is a flowchart showing an operation sequence at cache deletion timing. This operation sequence is performed for only a service of the Query-based Caching Method (a search-based accumulation system).

In Step 1, cache deletion date and time registered in the service/metadata information accumulating unit 19 is confirmed for each registration query (S401).

In Step 2, it is confirmed whether the cache deletion date and time that is acquired in Step 1 already elapsed the current time (S402). When the cache deletion date and time does not elapse (NO), the sequence is finished. On the other hand, when the cache deletion date and time already elapsed (YES), the process proceeds to Step 3.

In Step 3, cache (metadata) corresponding to a registration query that already elapsed the cache deletion date and time is deleted (S403), and the sequence is finished.

(3) Occurrence of Search Query from the User

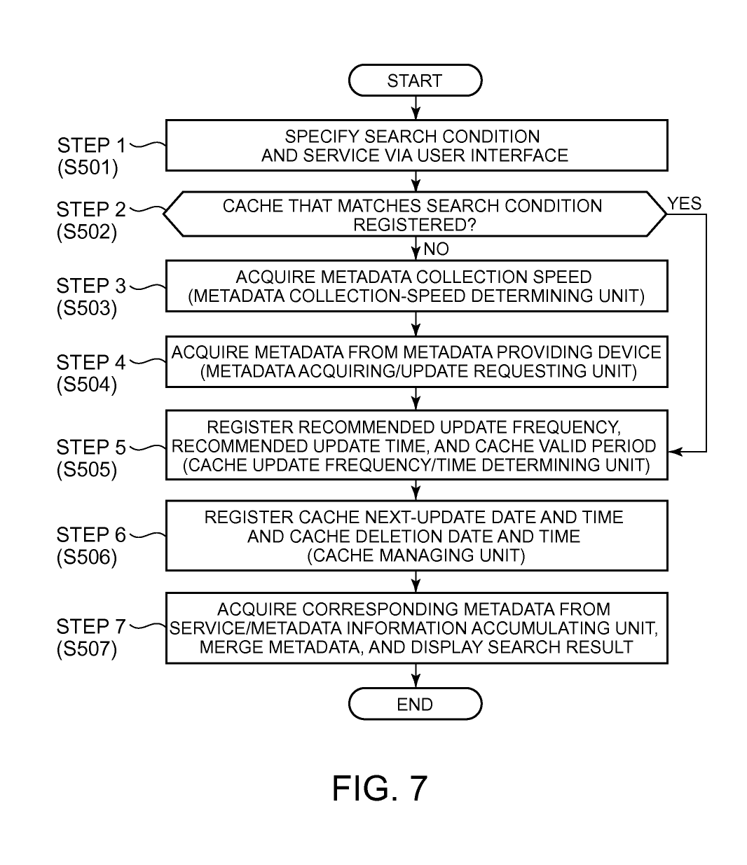

An operation sequence when there is a search query from the user is explained next with reference to FIG. 7.

FIG. 7 is a flowchart showing an operation sequence when there is a search query from the user.

In Step 1, a search condition of content and a service to be searched are specified on a search screen as shown in FIG. 10 (S501). In an example of FIG. 10, sports is assigned as “genre” and tennis is assigned as “keyword”, as a search condition, and a high-quality VoD service and a video posting service are assigned as “service to be searched”, for example. Promotion information such as recommended content and new arrival content may be a search condition, in addition to “genre” and “keyword”. A search query that specifies search conditions and services to be searched is transmitted from the user interface unit 11 to the cache managing unit 18.

In Step 2, the cache managing unit 18 decides a cache memory system for each assigned service in the service/metadata information accumulating unit 19, based on the search query received in Step 1. When the system is the All Caching Method (a prior accumulation system), the process unconditionally proceeds to Step 5. When the system is the Query-based Caching Method (a search-based accumulation system), the cache managing unit 18 decides whether a registration query that matches a search condition contained in the search query is already registered in the service/metadata information accumulating unit 19. When a registration query that matches a search condition contained in the search query is already registered in the service/metadata information accumulating unit 19 (YES at S502), the process proceeds to Step 5. When a registration query is not yet registered in the service/metadata information accumulating unit 19 (NO at S502), the process proceeds to Step 3.

When service information as shown in FIGS. 8 and 9 is already registered in the service/metadata information accumulating unit 19, for example, the process proceeds to Step 5 in the case of the high-quality VoD service, because this service is the All Caching Method (a prior accumulation system). On the other hand, in the video posting service, only a registration query of “Genre: Sports, Keyword: Tennis” is stored as cache. Therefore, when a search condition that is the same as this registration query is specified, the process proceeds to Step 5. When a search condition that is different from this registration query is specified, the process proceeds to Step 3.

In Step 3, the metadata collection-speed determining unit 14 determines a metadata collection speed (S503).

In Step 4, the cache managing unit 18 transmits the metadata collection speed determined in Step 3, a metadata collection number (a highly-ranked number), and service information (metadata acquisition information, for example), to the metadata acquiring/update requesting unit 17. The metadata acquiring/update requesting unit 17 collects metadata from the metadata providing device 102n, based on these pieces of information (S504). In acquiring metadata, the process may shift to Step 5 at a point of time when metadata of a minimum necessary number are acquired, from a viewpoint of presenting a search result as soon as possible. For example, when a number of metadata that can be displayed on one screen is five as shown in FIG. 11 and also when a metadata collection number requested from the cache managing unit 18 is 500, the process proceeds to Step 5 after 20 metadata are acquired, by also considering a shift of the screen. Remaining 480 metadata (=500−20) may be sequentially acquired after displaying a search result.

In Step 5, the cache update frequency/time determining unit 16 determines recommended update frequency, recommended update time, and a cache valid period, registers these pieces of information into the service/metadata information accumulating unit 19 (S505), and proceeds to Step 6. However, the cache valid time is determined only for a service of the Query-based Caching Method (a search-based accumulation system).

In Step 6, the cache managing unit 18 determines cache next-update date and time and cache deletion date and time, based on the recommended update frequency, the recommended update time, and the cache valid period, and registers the determined cache next-update date and time and cache deletion date and time into the service/metadata information accumulating unit 19 (S506). However, the cache deletion date and time is determined and registered only for a service of the Query-based Caching Method (a search-based accumulation system).

In Step 7, metadata are acquired from the service/metadata information accumulating unit 19 for all services to be searched (S507). That is, for services of the Query-based Caching Method (a search-based accumulation system), metadata that are associated with a registration query which matches a search condition are acquired from the service/metadata information accumulating unit 19. For services of the All Caching Method (a prior accumulation system), metadata that match a search condition are detected and acquired from the service/metadata information accumulating unit 19. The user interface unit 11 merges the metadata acquired from the service/metadata information accumulating unit 19, and displays the merged result (S507). FIG. 11 shows an example of displayed metadata. In this case, a merge method may be a one that displays according to assigned items. For example, a merge method displayed in an order of date or a name may be used.

As described above, according to the embodiment of the invention, the following effects can be obtained.

(1) Efficient metadata can be cached for each service, by selecting a cache system of metadata that suits the service.

(2) Cached metadata can be efficiently updated. For example, metadata of content in high demand can be generally held in a latest state, and meaningless update of metadata can be prevented for content in low demand.

(3) Influence of metadata collection to other application of a receiving terminal can be minimized. Influence attributable to disturbance can be minimized, by setting a metadata collection speed by considering network load and meta server load.

The metadata collecting device 101 can be also achieved by using a general-purpose computer device for basic hardware, for example. That is, a user interface unit, a cache system determining unit, a cache managing unit, a metadata collection-speed determining unit, a cache update frequency/time determining unit, a terminal/server/network load monitoring unit, and a metadata acquiring/update requesting unit can be achieved by causing a processor mounted on the computer device to execute a program. In this case, the metadata collecting device 101 can be arranged to be achieved by installing a program in advance into the computer device, or can be achieved by storing the program on a CD-ROM or the like into a recording medium or by distributing the program via a network, and by suitably installing the program into the computer device. The service/metadata information accumulating unit 19 can be achieved by suitably using a memory medium such as a memory, a hard disk, or a CD-R, a CD-RW, a DVD-RAM, a DVD-R that are incorporated internally or externally attached to the computer device.

### Second Embodiment

In the first embodiment, examples are explained that the metadata collecting device 101 selectively uses one of two kinds of accumulation systems (hereinafter, “cache system”) of the All Caching Method (a prior accumulation system) and the Query-based Caching Method (a search-based accumulation system). In a second embodiment, the metadata collecting device 101 includes the All Caching Method (a prior accumulation system), the Query-based Caching Method (a search-based accumulation system), and a Keyword-based Caching Method (a keyword-based prior accumulation system), as the caching systems. The metadata collecting device 101 selectively uses any one of the above three kinds of cache systems. In the following explanation, an explanation similar to that in the first embodiment is omitted, and points that are different from those in the first embodiment are mainly explained.

A content distribution system in the second embodiment is similar to that of the first embodiment (FIG. 1).

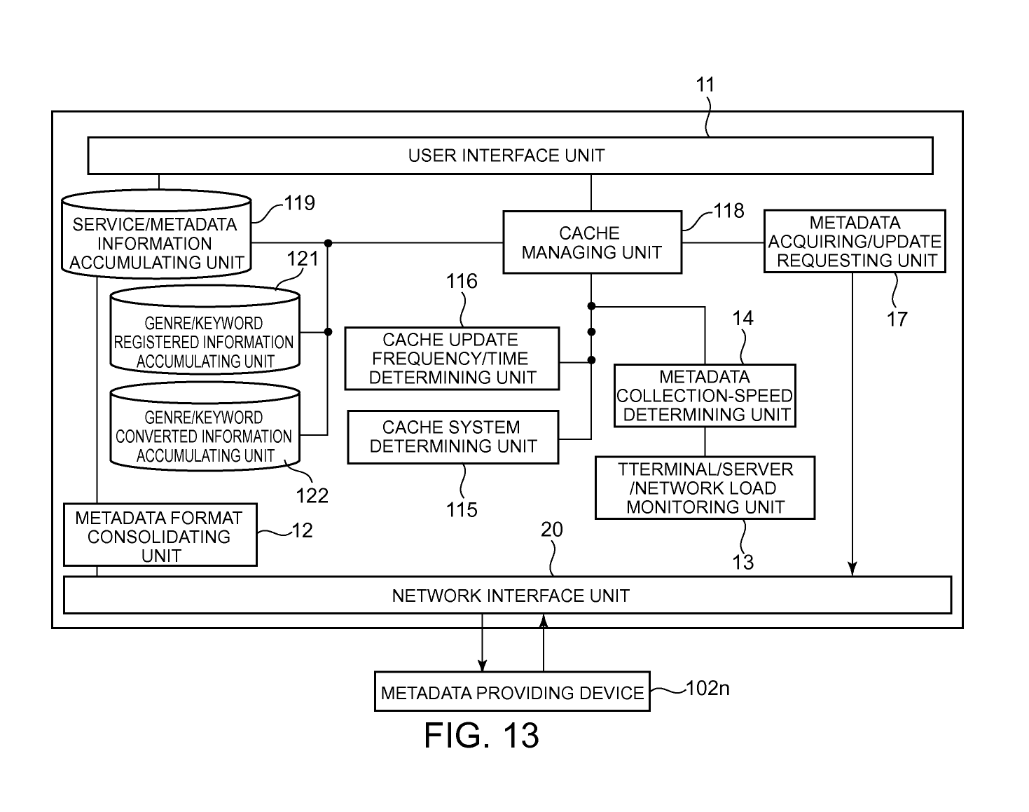

FIG. 13 is a block diagram showing a configuration of a metadata collecting device 101′ according to the second embodiment. The metadata collecting device 101′ according to the second embodiment shown in FIG. 13 is different from the metadata collecting device 101 (FIG. 2) according to the first embodiment in that the metadata collecting device 101′ additionally includes a genre/keyword registered information accumulating unit 121 and a genre/keyword converted information accumulating unit 122. Each functional block is explained below.

A cache system determining unit 115 in the embodiment is an accumulation system determining unit that determines for each service a cache system that stores metadata, like the cache system determining unit in the first embodiment. A service/metadata information accumulating unit 119 is a storage unit that stores for each cache system a start condition to acquire metadata, a search condition to select metadata to be acquired, and a finish condition to finish acquisition of metadata, and that further accumulates the acquired metadata. A cache managing unit 118 and the metadata acquiring/update requesting unit 17 are acquiring units that manage the start condition, the search condition, and the finish condition described above, and update of the accumulated metadata, and that acquire metadata from a network.

The user interface unit 11, the metadata format consolidating unit 12, the terminal/server/network load monitoring unit 13, the metadata collection-speed determining unit 14, the metadata acquiring/update requesting unit 17, and the network interface unit 20 are similar to those in the first embodiment. The cache system determining unit (an accumulation system determining unit) 115, a cache update frequency/time determining unit 116, the cache managing unit 118, the service/metadata information accumulating unit (an accumulating unit, a storage unit) 119, the genre/keyword registered information accumulating unit 121, and the genre/keyword converted information accumulating unit 122 are different from corresponding units in the first embodiment. Therefore, these functional blocks are explained below.

### [Service/Metadata Information Accumulating Unit (an Accumulating Unit, a Storage Unit) 119]

The service/metadata information accumulating unit (an accumulating unit, a storage unit) 119 is an accumulating unit that accumulates metadata acquired from the metadata providing devices 102a to 102e. That is the service/metadata information accumulating unit 119 accumulates service information that is set for each service. The service information includes cache systems determined by the cache system determining unit (an accumulation system determining unit) 115. The service/metadata information accumulating unit 119 also has a role of a storage unit that stores a cache system for each service, and is constituted by a hard disk or a nonvolatile memory.

FIGS. 8, 9, and 15 show examples of the service information. The service information includes the following items. However, depending on the cache system, all of these items are not necessarily included.

Number of corresponding services

Name of corresponding service

Cache system

Cache upper limit number

Metadata acquisition information

Registration query number

Registration query

Accumulated keywords/genres number

Accumulated keywords

Accumulated genres

Number of searches

Number of views

Recommended update frequency (cache update frequency)

Recommended update time (cache update time)

Cache next-update date and time

Cache valid period

Cache deletion date and time

Among the above items, items that are different from those in the first embodiment are explained below.

“Cache system” indicates a cache system that is determined by the cache system determining unit (an accumulation system determining unit) 115 described later. The cache system is one of the following.

Query-based Caching Method (a search-based accumulation system)

All Caching Method (a prior accumulation system)

Keyword-based Caching Method (a keyword-based prior accumulation system)

The All Caching Method (a prior accumulation system) is a system that caches in advance all metadata held by a service. The Query-based Caching Method (a search-based accumulation system) is a system that caches only a few highly-ranked number of metadata or all metadata for a search condition that is searched, each time when search is performed. The Keyword-based Caching Method (a keyword-based prior accumulation system) is a system that specifies a keyword or a genre to be cached in advance, and acquires content in advance based on the keyword or the genre. A method of specifying a keyword or a genre is described later.

“Cache upper limit number” indicates an upper limit value of a cached number for each search, and metadata are acquired and cached up to this upper limit number, in the case of the Query-based Caching Method (a search-based accumulation system). In the case of the Keyword-based Caching Method (a keyword-based prior accumulation system), “cache upper limit number” indicates an upper limit value of a cached number for each specified keyword, and metadata are accumulated up to this upper limit number.

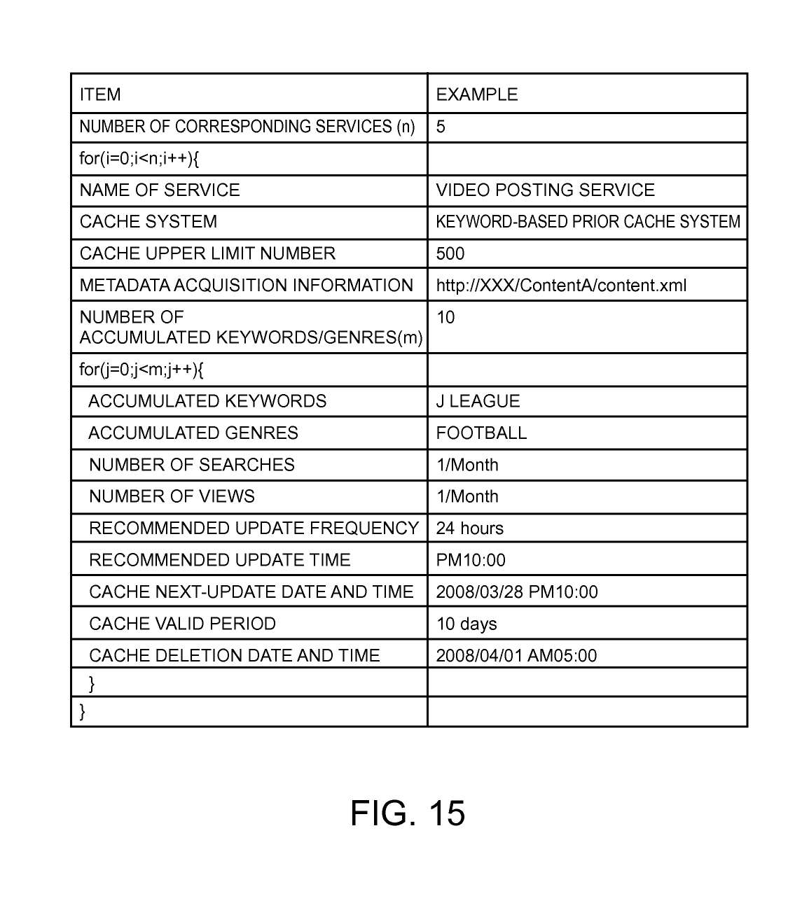

“Accumulated keywords/genres number” is a total number of accumulated keywords/genres that are cached in advance, in the Query-based Caching Method (a search-based accumulation system). In the example of the service information shown in FIG. 15, ten pairs of accumulated keywords/genres are registered. A set of items “accumulated keywords” to “cache deletion date and time” is used for each pair of accumulated keywords and accumulated genres.

“Accumulated keywords” indicates keywords of contents accumulated in advance. For this item, only when a cache system is the Keyword-based Caching Method (a keyword-based prior accumulation system), a keyword is set at a point of time when corresponding metadata is acquired from the metadata providing device 102n (102n indicates anyone of or plural devices of 102a to 102e). An item to be registered as “accumulated keywords” is not limited to keywords, and promotion information (recommendation, a new arrival, etc.) may be registered. Detailed examples of a method of registering a keyword are explained below.

Register at an initial time: This is a method of registering in advance a prefixed keyword list at an initial shipment time of a device.

Register manually: This is a method of explicitly specifying a keyword list to be acquired from the user interface unit 11.

Register a keyword by acquiring the keyword via a network: This is a method of acquiring a keyword list on a network, and specifying the acquired keyword. For example, the method includes such as acquiring a list of a keyword (a hot word, etc.) that is a recent topic, acquiring a keyword of a new arrival or popular content by the service, acquiring a file that describes a keyword list. However, a registration method is not limited to the above, and any method that can acquire a keyword from the outside of the device may be used.

“Accumulated genres” indicates genres of contents accumulated in advance. Genres of contents are registered in “accumulated genres”, only when a cache system is the Keyword-based Caching Method (a keyword-based prior accumulation system). The genre is registered at a point of time when the metadata collecting device 101′ acquires metadata from the metadata providing device 102n. In the case of searching by developing a genre to a keyword by using genre/keyword converted information, a search keyword and a genre for this search are registered together.

“Number of searches” indicates a number of searches for each accumulation word, or for each genre or registration query or service. “Number of searches” indicates a number of searches for each registration query when a cache system is the Query-based Caching Method (a search-based accumulation system), indicates a number of searches for each service when a cache system is the All Caching Method (a prior accumulation system), and indicates a number of searches for each keyword when a cache system is the Keyword-based Caching Method (a keyword-based prior accumulation system).

“Cache valid period” indicates a period while the cache is valid, and is determined by the cache update frequency/time determining unit 116 described later. The cache valid period is set only when a cache system is the Query-based Caching Method (a search-based accumulation system) or the Keyword-based Caching Method (a keyword-based prior accumulation system). The cache valid period is set as ten days, for example.

As described above, the service/metadata information accumulating unit 119 accumulates service information (metadata). The metadata is accumulated by unit of service when a cache system for a service is the All Caching Method (a prior accumulation system). The metadata is accumulated by unit of registration query for each service when a cache system for a service is the Query-based Caching Method (a search-based accumulation system). The metadata is accumulated by unit of registered keyword for each service when a cache system for a service is the Keyword-based Caching Method (a keyword-based prior accumulation system).

### [Genre/Keyword Registered Information Accumulating Unit 121]

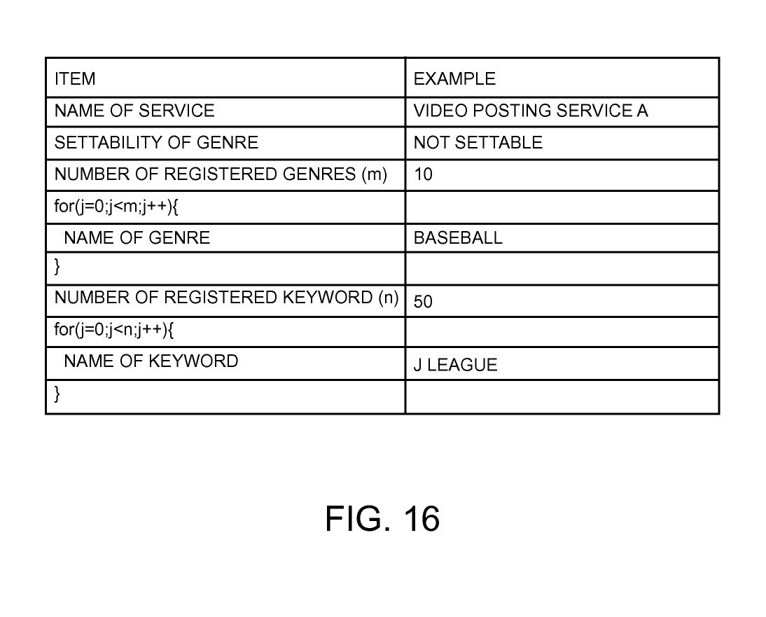

The genre/keyword registered information accumulating unit 121 accumulates genre/keyword registered information that is set for each service. The genre/keyword registered information is information to set a keyword or a genre to be accumulated in advance. The genre/keyword registered information is used only when a cache system is the Keyword-based Caching Method (a keyword-based prior accumulation system). The genre/keyword registered information accumulating unit 121 is constituted by a hard disk or a nonvolatile memory, for example. FIG. 16 shows an example of genre/keyword registered information. The genre/keyword registered information includes the following items.

Name of service

Settability of genre

Number of registered genre

Registered genre name

Number of registered keyword

Registered keyword

“Name of service” indicates a name of a registered service.

“Genre settability” indicates whether search is possible by using a genre in the service. When setting genre is not possible, genre is converted into a keyword according to genre/keyword converted information described later.

“Number of registered genre” indicates a number of registered genres.

“Registered genre name” indicates a name of a registered genre. In the example shown in FIG. 16, although a genre name is registered by a character string of “baseball”, the genre name maybe a numerical value (a genre code) that can be uniquely identified within a device.

“Number of registered keyword” indicates a number of registered keyword.

“Registered keyword” indicates a registered keyword.

A detailed example of a method of setting genre/keyword registered information into the genre/keyword registered information accumulating unit 121 is explained below.

Set at an initial shipment time: This is a method of setting genre/keyword registered information for each service in advance, at an initial shipment time of a device.

Register manually: This is a method of setting genre/keyword registered information from the user interface unit 11.

Register a genre keyword by acquiring the genre keyword via a network: This is a method of acquiring a genre keyword list on a network, and specifying the acquired genre keyword. For example, the method includes such as acquiring a list of a genre keyword (a hot word, etc.) that is a recent topic, acquiring a genre keyword of a new arrival or popular content by the service, or acquiring a file that describes a genre keyword list. However, a genre registration method is not limited to the above, and any method that can acquire a genre keyword from the outside of the device can be used.

An item to be registered is not limited to a genre keyword, and may be promotion information (new arrival information, recommended information, etc.).

[Genre/Keyword Converted Information Accumulating Unit 122]

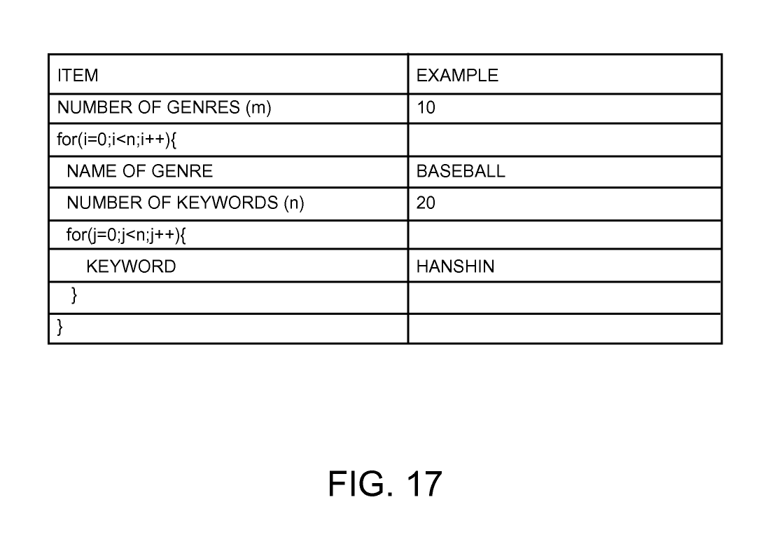

The genre/keyword converted information accumulating unit 122 accumulates genre/keyword converted information that is necessary to convert a genre into a keyword. Even when a genre cannot be included in a search condition, genre/keyword converted information is held in the genre/keyword converted information accumulating unit 122, to make metadata of a service searchable. The genre/keyword converted information accumulating unit 122 is constituted by a hard disk or a nonvolatile memory, for example. FIG. 17 shows an example of genre/keyword converted information. The genre/keyword converted information includes the following items.

Number of genre

Genre name

Number of keyword

Keyword

“Number of genre” indicates a number of set genres.

“Genre name” indicates a name of a set genre.

“Number of keyword” indicates a number of keywords that are set in the genre.

“Keyword” indicates a keyword name that is set in the genre.

A detailed example of a method of setting genre/keyword converted information into the genre/keyword converted information accumulating unit 122 is explained below.

Set at an initial shipment time: This is a method of setting genre/keyword converted information in advance, at an initial shipment time.

Register manually: This is a method of setting genre/keyword converted information from the user interface unit 11.

Register genre/keyword converted information by acquiring this information via a network: For example, a file of genre/keyword converted information is provided in a server on the network. The metadata collecting device 101′ acquires this file from the server, and sets the file into the genre/keyword converted information accumulating unit 122. However, a method of registering genre/keyword converted information is not limited to the above, and any method that can acquire genre/keyword converted information from the outside of the device may be used.

### [Cache System Determining Unit (an Accumulation System Determining Unit) 115]

The cache system determining unit (an accumulation system determining unit) 115 determines a cache system for each service that is registered in the service/metadata information accumulating unit 119. A determined cache system is registered into the service/metadata information accumulating unit (a storage unit) 119 via the cache managing unit 18. The cache system is selected from any one of the following systems (1), (2), (3). Alternatively, (2) and (3) maybe selected together.

### (1) All Caching Method (a Prior Accumulation System)

This is the same method as that in the first embodiment, and therefore, explanation of this system is omitted.

### (2) Query-Based Caching Method (a Search-Based Accumulation System)

This is the same method as that in the first embodiment, and therefore, explanation of this system is omitted.

### (3) Keyword-Based Caching Method (a Keyword-Based Prior Accumulation System)

The Keyword-based Caching Method (a keyword-based prior accumulation system) does not cache in advance metadata that is held (provided) by the service, but caches only highly-ranked number of metadata for each keyword, and/or genre acquired from keyword/genre registration information that is being managed by the genre/keyword registered information accumulating unit 121. The highly-ranked number of metadata are determined for each service in advance, (500, for example), and a request is made to the metadata providing device 102n to transmit highly-ranked number of metadata (500) as a maximum. When metadata transmitted from the metadata providing device 102n exceeds the highly-ranked number of metadata as a result of requesting the metadata providing device 102n to transmit all metadata that match a search condition, it can be arranged such that only the highly-ranked number of metadata are selected from among these metadata. In this case, a selection standard may be arbitrary, and first acquired highly-ranked number of metadata can be selected, for example. When a priority is attached to metadata, highly-ranked number of metadata may be selected from metadata in the order from a higher priority.

In the Keyword-based Caching Method (a keyword-based prior accumulation system), a search formula for each service is generated based on a registered keyword, and metadata are collected from the metadata providing device 102n. Thereafter, metadata is updated at periodical update timing by unit of search formula (that is, by unit of a keyword or genre). In updating, metadata of each registration query (a search condition) are acquired again up to an upper limit number, by deleting cache. Alternatively, when only a difference can be acquired, only the difference is acquired again, without clearing cache once. However, a cache number of each registered keyword and genre is up to a certain upper limit number.

The cache system determining unit (an accumulation system determining unit) 115 determines a cache system following any of the following indicators (A) to (C). However, when any indicator is used, capacity (hard disk or memory capacity) of the service/metadata information accumulating unit 119 is taken into consideration.

### (A) Manual

The user determines a cache system for each service. For example, the user determines a cache system in a pop-up screen displayed.

### (B) Pre-Configure

A cache system corresponding to each service is registered in advance in the service/metadata information accumulating unit 119. For example, the All Caching Method (a prior accumulation system) is registered in advance for a high-quality VoD video service, because a number of contents is limited in this service. The Query-based Caching Method (a search-based accumulation system) or the Keyword-based Caching Method (a keyword-based prior accumulation system) is registered in advance for a video posting service, because a number of contents is very large in this service.

### (C) Auto

A cache system to be used is automatically selected. Decision is based on any of the following decision standards. However, the decision is not limited to these decision standards, and any decision standard may be used as long as a cache system can be selected.

The All Caching Method (a prior accumulation system) is selected when a total holding number of contents (a total number of metadata) can be acquired from a service and also when a total number of contents (a total number of metadata) is equal to or smaller than a certain threshold value. In other cases, the Query-based Caching Method (a search-based accumulation system) or the Keyword-based Caching Method (a keyword-based prior accumulation system) or both methods are selected. The threshold value may be a fixed quantity or may be determined based on capacity of a hard disk.

A cache system is selected according to a kind or quality of a network, not for each service. For example, the All Caching Method (a prior accumulation system) is selected for a service provided by a metadata providing device on a home network or a quality-managed network. On the other hand, the Query-based Caching Method (a search-based accumulation system) or the Keyword-based Caching Method (a keyword-based prior accumulation system) or both methods are selected, for a service that is provided by the metadata providing device on the Internet. The All Caching Method (a prior accumulation system) is selected, for a service that is provided by the metadata providing device on a network in which contents are distributed by Digital Living Network Alliance (DLNA). For other networks, the Query-based Caching Method (a search-based accumulation system) or the Keyword-based Caching Method (a keyword-based prior accumulation system) or both methods are selected.

A cache system is selected based on a kind of service. For example, the All Caching Method (a prior accumulation system) is selected, for a charged service. On the other hand, the Query-based Caching Method (a search-based accumulation system) or the Keyword-based Caching Method (a keyword-based prior accumulation system) or both methods are selected for a free service.

A cache system is selected based on update frequency of metadata. Because update frequency of metadata is also closely linked to a total number of metadata, a service for which update frequency of metadata is low is assumed to have a small total number of contents. For example, because a service for which update frequency is low has a small number of cache update, the All Caching Method (a prior accumulation system) is selected for this service. On the other hand, the Query-based Caching Method (a search-based accumulation system) or the Keyword-based Caching Method (a keyword-based prior accumulation system) or both methods are selected for a service for which update of cache is frequent.

### [Cache Update Frequency/Time Determining Unit 116]

The cache update frequency/time determining unit 116 determines recommended update frequency (update frequency), recommended update time (an update time zone) of cache, and a cache valid period by unit of update (by unit of service, by unit of registration query, by unit of registered keyword, by unit of a registered genre) according to a cache system, based on an instruction from the cache managing unit 18, and registers these pieces of information in the service/metadata information accumulating unit 119. The cache update frequency/time determining unit 116 determines the recommended update frequency, the recommended update time, and the cache valid period, by a method similar to that in the first embodiment.

A cache update unit is different depending on a cache system. The All Caching Method (a prior accumulation system) is updated by unit of service and the Query-based Caching Method (a search-based accumulation system) is updated by unit of registration query. The Keyword-based Caching Method (a keyword-based prior accumulation system) is updated by unit of registration keyword or by unit of registration genre.

Cache is deleted only when a cache system is the Query-based Caching Method (a search-based accumulation system) or the Keyword-based Caching Method (a keyword-based prior accumulation system). Therefore, the cache valid period is registered in the service/metadata information accumulating unit 119 only in the case of the Query-based Caching Method (a search-based accumulation system) or the Keyword-based Caching Method (a keyword-based prior accumulation system).

### [Cache Managing Unit 118]

The cache managing unit 118 mainly manages update of accumulation system information such as a start condition to acquire metadata, a search condition and a finish condition, and update of metadata that are accumulated in the service/metadata information accumulating unit (an accumulating unit) 119. The cache managing unit 118 plays a role of an acquiring unit, together with the metadata acquiring/update requesting unit 17. The accumulation system information is determined for each cache system. For example, in the case of the All Caching Method (a prior accumulation system), the start condition is a cyclically-determined time. The search condition is an identifier or a search formula that indicates to acquire metadata of all contents provided by a service. The finish condition is a completion time of acquisition of metadata of all contents according to the search condition.

In the case of the Query-based Caching Method (a search-based accumulation system), the start condition is a time when a metadata acquisition request is notified from the user interface unit 11. The search condition is a predetermined search formula. The finish condition is a time when acquisition of metadata that matches the search formula is completed up to a predetermined threshold value.

In the case of the Keyword-based Caching Method (a keyword-based prior accumulation system), the start condition is a cyclically-determined time. The search condition is a predetermined search formula. The finish condition is a time when acquisition of metadata that matches the search formula is completed up to a predetermined threshold value.

These pieces of the accumulation system information are stored in the service/metadata information accumulating unit 119 for each cache system. The cache managing unit 118 acquires the accumulation system information from the service/metadata information accumulating unit 119, and notifies the accumulation system information to the metadata acquiring/update requesting unit 17.

Details of the cache managing unit are described below.

The cache managing unit 118 confirms whether a cache system is already registered for each service registered in the service/metadata information accumulating unit 119. When a cache system is not yet registered for a certain service, the cache managing unit 118 requests the cache system determining unit (an accumulation system determining unit) 115 to determine a cache system. The cache managing unit 118 registers the cache system determined by the cache system determining unit (an accumulation system determining unit) 115 into the service/metadata information accumulating unit (a storage unit) 119.

A process of the cache managing unit 118 when a cache system is the All Caching Method (a prior accumulation system) or the Query-based Caching Method (a search-based accumulation system) is similar to that in the first embodiment. A process of the cache managing unit 118 when a cache system is the Keyword-based Caching Method (a keyword-based prior accumulation system) is described below.

The cache managing unit 118 acquires all metadata held by the metadata providing device 102n from the metadata providing device 102n. The cache managing unit 118 stores the acquired metadata in the service/metadata information accumulating unit 119 by associating the acquired metadata with this service. Particularly, at an initial activation time, the cache managing unit 118 acquires metadata corresponding to the registered keyword or genre from the metadata providing device 102n. The cache managing unit 118 stores the acquired metadata in the service/metadata information accumulating unit 119 by associating the acquired metadata with a service and a keyword or a genre. When a genre is already registered, the cache managing unit 118 may acquire metadata corresponding to a keyword converted from the genre, from the metadata providing device 102n, by using genre/keyword converted information. In this case, the genre and the keyword are registered together in advance in the service/metadata information accumulating unit 119.

In acquiring metadata, the cache managing unit 118 acquires a metadata collection speed from the metadata collection-speed determining unit 14, and notifies the acquired metadata collection speed to the metadata acquiring/update requesting unit 17. At the same time, the cache managing unit 118 notifies a service to be searched, a search condition, and a metadata collection number to the metadata acquiring/update requesting unit 17. The cache managing unit 118 decides a cache system of a service to be searched, when the cache managing unit 118 receives a search query (a query that specifies a search condition and a service to be searched) from the user interface unit 11.

The cache managing unit 118 also performs a metadata search process. When a cache system is the Keyword-based Caching Method (a keyword-based prior accumulation system) as a result of deciding the cache system, the cache managing unit 118 determines whether a registered keyword/genre that matches a search condition in the search query is present. When a registered keyword that matches a search condition is present, the cache managing unit 118 acquires metadata corresponding to the registered keyword/genre from the service/metadata information accumulating unit 119, and displays the metadata via the user interface unit 11. When a registered keyword that matches a search condition is not present, the cache managing unit 118 requests the metadata acquiring/update requesting unit 17 to acquire metadata, and displays the acquired metadata via the user interface unit 11. The cache managing unit 118 also stores the acquired metadata into the service/metadata information accumulating unit 119 by associating the acquired metadata with a search condition (a registration query) of a service to be searched. When a genre is assigned in a search condition, the cache managing unit 118 can refer to genre/keyword converted information in the genre/keyword converted information accumulating unit 122, convert the genre into a keyword, and request the metadata acquiring/update requesting unit 17 to acquire metadata.

The cache managing unit 118 instructs the cache update frequency/time determining unit 116 to calculate recommended update frequency and recommended update time of cache and a cache valid period, when there is a search query, when metadata is newly acquired, or when cache metadata is updated. The cache managing unit 118 registers the calculated recommended update frequency, recommended update time of cache and a calculated cache valid period into the service/metadata information accumulating unit 119.

The cache managing unit 118 determines cache next-update date and time based on the recommended update time and recommended update frequency of cache and the last update date and time, and registers the cache next-update date and time into the service/metadata information accumulating unit 119. The cache managing unit 118 determines cache deletion date and time based on the cache valid period and the last update date and time, and registers the cache deletion date and time into service/metadata information accumulating unit 119. In determining cache next-update date and time, the cache managing unit 118 may prioritize any one of the recommended update frequency and the recommended update time. For example, in the case of “last update time: 2008/04/03 PM4:00, recommended update frequency: two days, recommended update time: AM3:00”, cache next-update date and time may be 2008/04/05 PM4:00 or may be 2008/04/05 AM3:00.

The cache managing unit 118 periodically monitors service information that is being managed by the service/metadata information accumulating unit 119, and performs update/deletion of cache. That is, the cache managing unit 118 confirms cache next-update date and time (an update condition) and cache deletion date and time. The cache managing unit 118 deletes cache when the cache deletion date and time elapsed, and updates metadata when cache update date and time elapsed (when an update condition is established).

### [Operation Sequence]

An operation sequence of the metadata collecting device 101′ at an initial activation time when a cache system is the Keyword-based Caching Method (a keyword-based prior accumulation system) according to the embodiment is explained below. An operation sequence of the metadata collecting device 101′ when a cache system is the All Caching Method (a prior accumulation system) or the Query-based Caching Method (a search-based accumulation system) is similar to that in the first embodiment. Other operation sequences (an operation at second and subsequent activation times or cache update/deletion timing) in the Keyword-based Caching Method (a keyword-based prior accumulation system) are similar to those in the Query-based Caching Method (a search-based accumulation system) in the first embodiment.

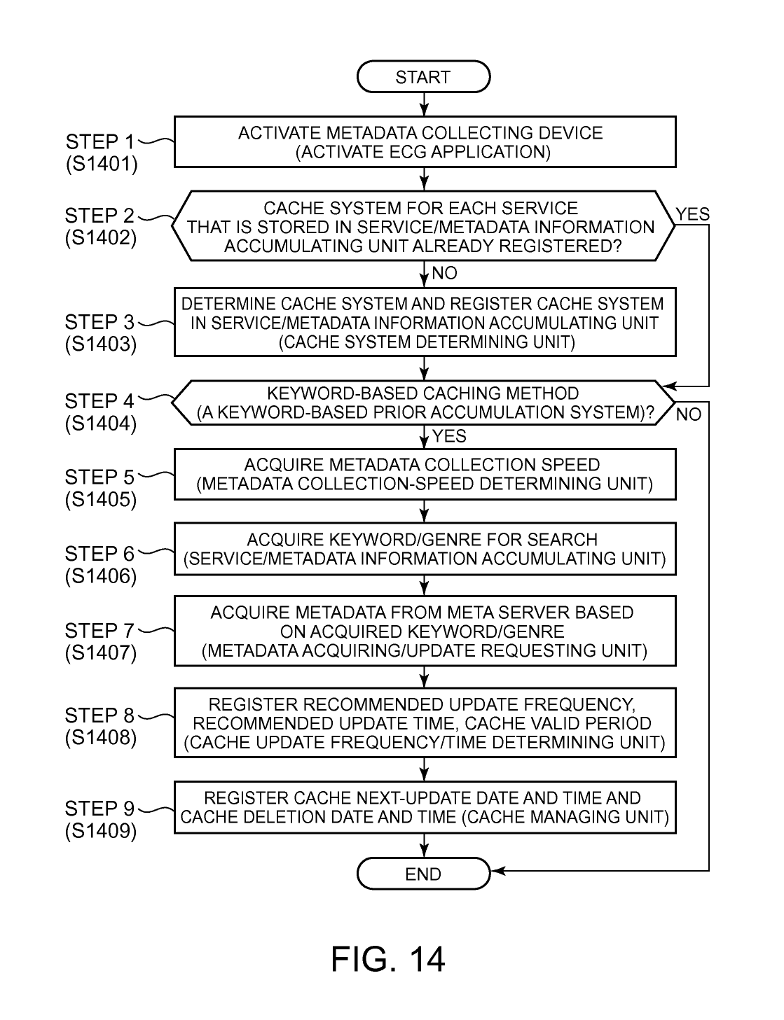

FIG. 14 is a flowchart showing an operation sequence performed at an initial activation time of the metadata collecting device 101′. The activation of the metadata collecting device 101′ means activation of a metadata collection application such as ECG.

In Step 1, the metadata collecting device 101′ is activated. That is, the ECG application is activated (S1401).

In Step 2, it is confirmed whether a cache system for each service that is stored in the service/metadata information accumulating unit 119 already registered (S1402). When a cache system is registered in advance for each service (YES), the process proceeds to Step 4. When there is a service for which a cache system is not yet registered (NO), the process proceeds to Step 3.

In Step 3, the cache system determining unit 115 determines a cache system for each service, and registers a determined cache into the service/metadata information accumulating unit 119 (S1403). A cache system is determined based on the decision standard described above. The Keyword-based Caching Method (a keyword-based prior accumulation system) is selected as a cache system, for example.

In Step 4, it is determined whether a cache system of a focused service is the Keyword-based Caching Method (a keyword-based prior accumulation system) (S1404). When a cache system is the Keyword-based Caching Method (a keyword-based prior accumulation system), the process proceeds to Step 5. When a cache system is other than the Keyword-based Caching Method (a keyword-based prior accumulation system), the operation shifts to operation in Step 4 and afterward of the sequence in FIG. 3 in the first embodiment.

In Step 5, the metadata collection-speed determining unit 14 determines a metadata collection speed (S1405).

In Step 6, the cache determining unit 118 acquires registered genre and keyword for each service from the genre/keyword registered information accumulating unit 121. For a service to which the genre is unsettable, the cache determining unit 118 acquires genre/keyword converted information from the genre/keyword converted information accumulating unit 122, and converts the genre into a keyword (S1406).

In Step 7, the cache determining unit 118 transmits a metadata collection speed determined in Step 5, a metadata collection number, and service information (a start condition for metadata acquisition, a search condition, a finish condition, and the like for example), and a keyword and a genre acquired in Step 6, to the metadata acquiring/update requesting unit 17. The metadata acquiring/update requesting unit 17 collects metadata from the metadata providing device 102n, based on these pieces of information (S1407). The metadata collection number is a cache upper limit number for each keyword accumulated in the service/metadata information accumulating unit 119. When a number of keywords/genres acquired in Step 6 is large, a number of metadata to be collected is calculated according to a hard disk capacity and the like, and only a calculated number of metadata may be arranged to be collected.

In Step 8, the cache update frequency/time determining unit 116 determines recommended update frequency and recommended update time, and registers the determined recommended update frequency and recommended update time into the service/metadata information accumulating unit 119 (S1408).

In Step 9, the cache managing unit 118 determines cache next-update date and time based on the recommended update frequency and the recommended update time, registers the determined cache next-update date and time into the service/metadata information accumulating unit 119 (S1409), and ends the sequence.

As described above, according to the embodiment of the invention, the following effects can be obtained.
(1) Efficient metadata can be cached for each service, by selecting a cache system of metadata that suits the service.
(2) Cached metadata can be efficiently updated. For example, metadata of content in high demand can be generally held in a latest state, and meaningless update of metadata can be prevented for content in low demand.
(3) Influence of metadata collection to other application of a receiving terminal can be minimized. Influence due to disturbance can be minimized, by setting a metadata collection speed by considering network load and meta server load.

The invention is not limited to the above embodiments, and can be achieved by modifying constituent elements within a range not deviating from the gist of the invention. Various inventions can be formed by suitably combining plural constituent elements disclosed in the above embodiments. For example, various constituent elements can be deleted from whole constituent elements disclosed in the embodiments. Further, constituent elements in different configurations can be suitably combined.

What is claimed is:

1. A metadata collecting device that acquires metadata from one or more metadata providing devices that hold contents and metadata of the contents distributed from one or more content distribution services, and accumulates the acquired metadata, the metadata collecting device comprising:
an accumulation system determining unit that determines an accumulation system for each service from among a plurality of accumulation systems that accumulate the metadata;
a storage unit that stores for each accumulation system accumulation system information which is uniquely determined from a start condition to start acquiring the metadata, a search condition to select the metadata to be acquired, and a finish condition to finish acquiring the metadata;
an acquiring unit that acquires corresponding metadata according to the accumulation system information for each service; and
an accumulating unit that stores the acquired metadata.

2. The metadata collecting device according to claim 1,
wherein the search condition is any one of identification information that indicates all metadata which are held by a specific service or a predetermined search formula, and
the acquiring unit acquires all the metadata of the specific service when the search condition is the identification information, and acquires the metadata that matches the search formula when the search condition is the search formula.

3. The metadata collecting device according to claim 2,
wherein the start condition is any one of a time at which it is determined to periodically acquire metadata or an acquisition request of the metadata from a user, and
the acquiring unit starts acquisition of the metadata at a reach of the time when the start condition is the time, and starts acquisition of the metadata at a notification of the acquisition request when the start condition is the acquisition request.

4. The metadata collecting device according to claim 3,
wherein the finish condition is anyone of a predetermined threshold value or identification information that indicates all metadata that a specific service has, and
the acquiring unit finishes acquisition of the metadata when a number of the acquired metadata matches the threshold value when the finish condition is the threshold value, and finishes acquisition of the metadata when all the metadata of the specific service are acquired when the finish condition is the identification information.

5. The metadata collecting device according to claim 4,
wherein the storage unit further stores for each service an update condition of the metadata that are accumulated in the accumulating unit, and
the acquiring unit acquires for each service all the metadata that match the update condition out of the metadata that are accumulated in the accumulating unit, or a difference between the metadata that are accumulated in the accumulating unit and the metadata that are held by the network.

6. The metadata collecting device according to claim 5,
wherein the update condition is any one of identification information that indicates all metadata which are held by a specific service or a predetermined search formula, and
the acquiring unit acquires all the metadata of the specific service when the search condition is the identification information, and acquires the metadata that match the search formula when the search condition is the search formula.

7. The metadata collecting device according to claim 6,
wherein the update condition further includes update frequency or an update time zone, and
the acquiring unit acquires the metadata fat least according to the update frequency or the update time zone.

8. The metadata collecting device according to claim 1,
wherein the accumulation system determining unit determines the accumulation system based on at least one of a kind or quality of the network, or based on at least one of a kind or a feature of the service.
